(19) United States
(12) Patent Application Publication
(10) Pub. No.: US 2008/0065676 A1
(43) Pub. Date: Mar. 13, 2008

(54) System and method for tracing data storage devices

(76) Inventors: Curtis B. Hause, St. Paul, MN (US); Stephen J. Rothermel, Roseville, MN (US); Jody L. Gregg, Lake Elmo, MN (US); G. Phillip Rambosek, Shafer, MN (US); Yung Yip, Afton, MN (US); Kevin G. Battles, Wahpeton, ND (US); Sanjay Gupta, Woodbury, MN (US); Robert C. Martin, St. Paul, MN (US); Christopher Caprio, Stillwater, MN (US); Karen E. Conroy, Oakdale, MN (US)

Correspondence Address: Imation Corp., PO Box 64898, St. Paul, MN, 55164-0898, US

(21) Appl. No.: 11/520,459

(22) Filed: Sep. 13, 2006

(51) Int. Cl. G06F 7/00

(52) U.S. Cl. 707/102; 700/225

(57) ABSTRACT

An electronic data storage device tracing system includes at least one data storage device and a reader system. The data storage device includes a housing having an optical label and a device RFID tag coupled to the housing. In this regard, the optical label is printed with a volser number and the device RFID tag includes a chip that electronically stores the volser number. The reader system is configured to read the volser number from the chip and trace the at least one data storage device entering/exiting the reader system.

### BACKGROUND

Data storage devices have been used for decades in computer, audio, and video fields for storing large volumes of information for subsequent retrieval and use. Data storage devices continue to be a popular choice for backing up data and systems.

Data storage devices include data storage tape cartridges, hard disk drives, micro disk drives, business card drives, and removable memory storage devices in general. These data storage devices are useful for storing data and for backing up data systems used by businesses and government entities. For example, businesses routinely backup important information such as human resource data, employment data, compliance audits, and safety/inspection data. Government sources collect and store vast amounts of data related to tax payer identification numbers, income withholding statements, and audit information. Congress has provided additional motivation for many publicly traded companies to ensure the safe retention of data and records related to government required audits and reviews after passage of the Sarbanes-Oxley Act (Pub. L. 107-204, 116 Stat. 745 (2002)).

Collecting and storing data has now become a routine business practice. In this regard, the data can be generated in various formats by a company or other entity, and a backup or backups of the same data is often saved to one or more data storage devices that is/are typically shipped or transferred to an offsite repository for safe/secure storage. Occasionally, the backup data storage devices are retrieved from the offsite repository for review and/or updating. With this in mind, the transit of data storage devices between various facilities introduces a possible risk of loss or theft of the devices and the data stored that is stored on the devices.

Users of data storage devices have come to recognize a need to safely store, retain, and retrieve the devices. For example, backing up data systems can occur on a daily basis. Compliance audits and other inspections can require that previously stored data be produced on an “as-requested” basis. With this in mind, it is both desirable and necessary for a user of data storage devices to be able to identify what data is stored on which device, and to locate where a specific device is. To complicate the general matter of identifying one device from another, the consumer often chooses to identify their “used” data storage devices by some form of a familiar or user-generated consumer number, which can be a non-unique number. Thus, tracking the data stored and tracing where the device is located is a challenging task.

The issue of physical data security and provenance is a growing concern for users of data storage devices. Thus, manufacturers and users both are interested in systems and/or processes that enable tracing and tracking of data storage devices. Improvements to the tracing and ability to immediately locate data storage devices used to store vital business data is needed by a wide segment of both the public and private business sector.

### SUMMARY

One aspect of the present invention provides an electronic data storage device tracing system. The tracing system includes at least one data storage device and a reader system. The data storage device includes a housing having an optical label and a device radiofrequency identification (RFID) tag coupled to the housing. In this regard, the optical label is printed with a volser number and the device RFID tag includes a chip that electronically stores the volser number. The reader system is configured to read the volser number from the chip and trace the data storage device(s) entering/exiting the reader system.

Another aspect of the present invention provides an electronic data storage device tracing system. The electronic data storage device tracing system includes means for instantaneously reading volser data for a plurality of data storage devices, means for compiling a report related to the volser data, and means for tracing the plurality of data storage devices based upon the compiled report.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a perspective view of an electronic data storage device tracing system according to one embodiment of the present invention;

FIG. 2 illustrates a perspective, exploded view of a data storage device including an optical label and a device RFID tag according to one embodiment of the present invention;

FIG. 3A illustrates a top view of a device RFID tag according to one embodiment of the present invention;

FIG. 3B illustrates a top view of a device RFID tag according to another embodiment of the present invention;

FIG. 3C illustrates a side view of a label including the device RFID tag illustrated in FIG. 3A;

FIG. 4A illustrates a cross-sectional view of a portion of a housing of the data storage device illustrated in FIG. 2 including the device RFID tag attached to an interior surface of the housing;

FIG. 4B illustrates a cross-sectional view of a portion of the housing of the data storage device illustrated in FIG. 2 including a device RFID tag attached to an exterior surface of the housing;

FIG. 5A illustrates a micro hard drive data storage device according to one embodiment of the present invention;

FIG. 5B illustrates a micro hard drive data storage device according to another embodiment of the present invention;

FIG. 6 illustrates a cross-sectional view of a pad antenna of the tracing system illustrated in FIG. 1;

FIG. 7 illustrates a planar view of a program operable by a graphical user interface of the tracing system illustrated in FIG. 1;

FIG. 8 illustrates another planar view of the program illustrated in FIG. 7;

FIG. 9 illustrates another planar view of the program illustrated in FIG. 7;

FIG. 10 illustrates another planar view of the program illustrated in FIG. 7;

FIG. 11A illustrates multiple data storage devices disposed within a case that is positioned proximate to a reader system of the tracing system illustrated in FIG. 1 in accordance with one embodiment of the present invention;

FIG. 11B illustrates a front view of a handheld portable reader device of the reader system illustrated in FIG. 11A;

FIG. 11C illustrates a top view of the case on the reader system illustrated in FIG. 1A;

FIG. 12 illustrates an exploded, perspective view of the case illustrated in FIG. 11A including a cover insert according to one embodiment of the present invention;

FIG. 13A illustrates a cross-sectional view of an insert lock according to one embodiment of the present invention;

FIG. 13B illustrates a cross-sectional view of an insert lock according to another embodiment of the present invention;

FIG. 13C illustrates a cross-sectional view of an insert lock including a retainer assembly according to another embodiment of the present invention;

FIG. 14A illustrates a perspective, exploded view of a case and an insert system configured to retain multiple data storage devices according to one embodiment of the present invention;

FIG. 14B illustrates a side view of multiple data storage devices retained by a base insert of the insert system illustrated in FIG. 14A;

FIG. 15 illustrates a cross-sectional view of the insert system of FIG. 14A retained within the case;

FIG. 16 illustrates a perspective view of a label printer including a label scanner and an RFID reader according to one embodiment of the present invention;

FIG. 17 illustrates a reader system including a U-shaped antenna assembly according to one embodiment of the present invention;

FIG. 18 illustrates a reader system including an adjustable antenna assembly according to one embodiment of the present invention;

FIG. 19A illustrates a reader system including a flip antenna assembly according to one embodiment of the present invention;

FIG. 19B illustrates two antenna panels of the flip antenna assembly shown in FIG. 19A deployed orthogonally;

FIG. 20 illustrates a reader system including a portable antenna assembly according to one embodiment of the present invention; and

FIG. 21 illustrates a flow chart of a process for tracing one or more data storage devices in transit according to one embodiment of the present invention.

### DETAILED DESCRIPTION

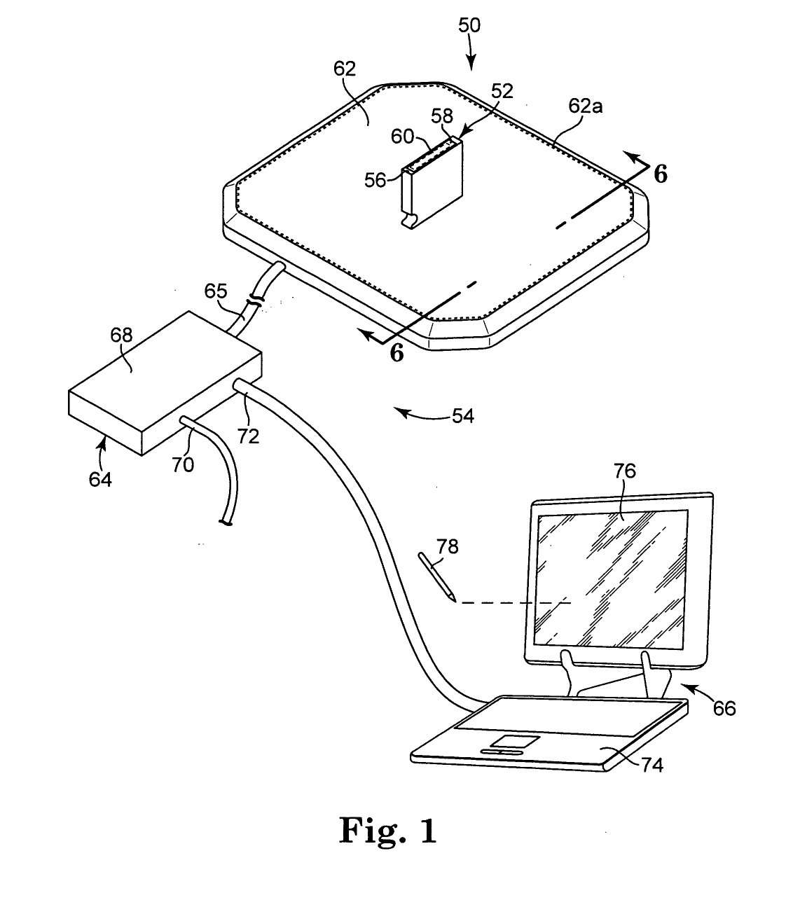

FIG. 1 illustrates a perspective view of an electronic data storage device tracing system 50 according to one embodiment of the present invention. The tracing system 50 includes a data storage device 52 and a reader system 54 configured to trace the data storage device 52 as it enters and leaves a facility, for example. In particular, in one embodiment the data storage device 52 includes a housing 56 having an optical label 58 and a device radio frequency identification (RFID) tag 60 coupled to the housing 56. The optical label 58 is printed with multiple data fields, including at least one specific data field related to a volser number for the data storage device 52, as described in detail below.

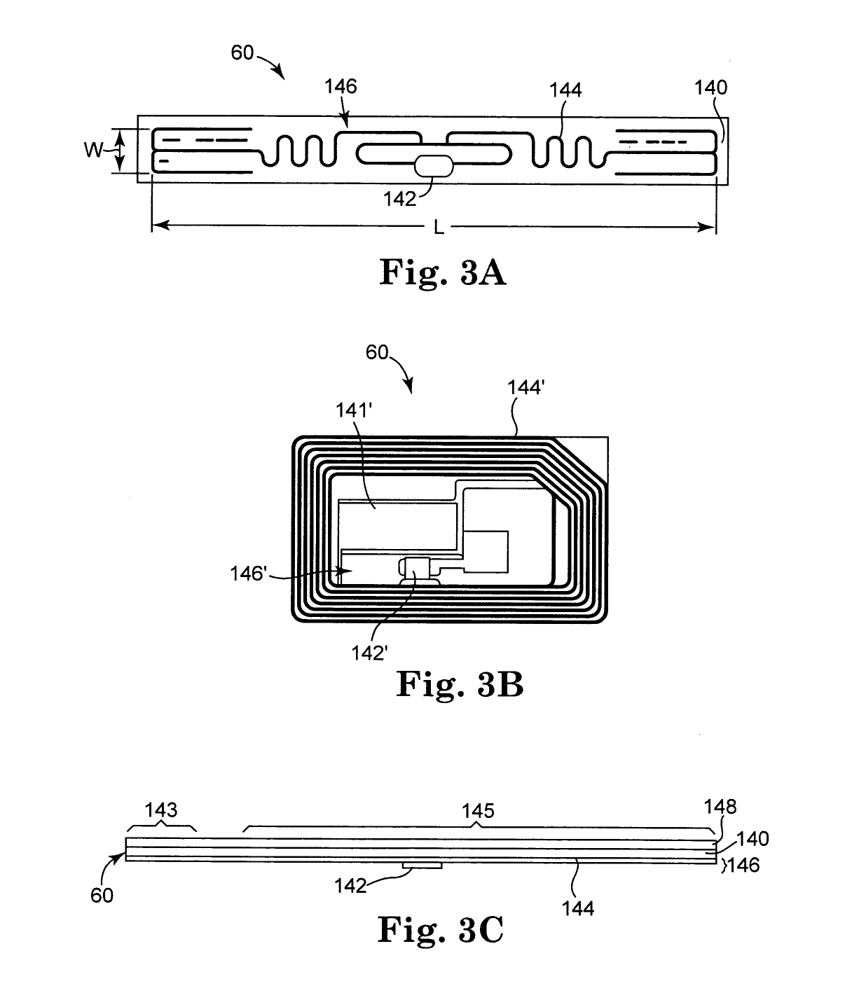

The device RFID tag 60 includes an electronic chip (See FIG. 3A) that is configured to electronically store multiple fields of data, including an electronic volser number that corresponds to the volser number that is printed on the optical label 58. In this manner, the volser number that is printed on the optical label 58 is readable by any number of optical reading systems, including electronic optical reading systems and users looking at the optical label 58. The reader system 54 is configured to electronically read the volser number from the device RFID tag 60 and create a record including at least a time at which the data storage device 52 is proximate the reader system 54. In this manner, the data storage device 52 is traced as it exits or enters a facility.

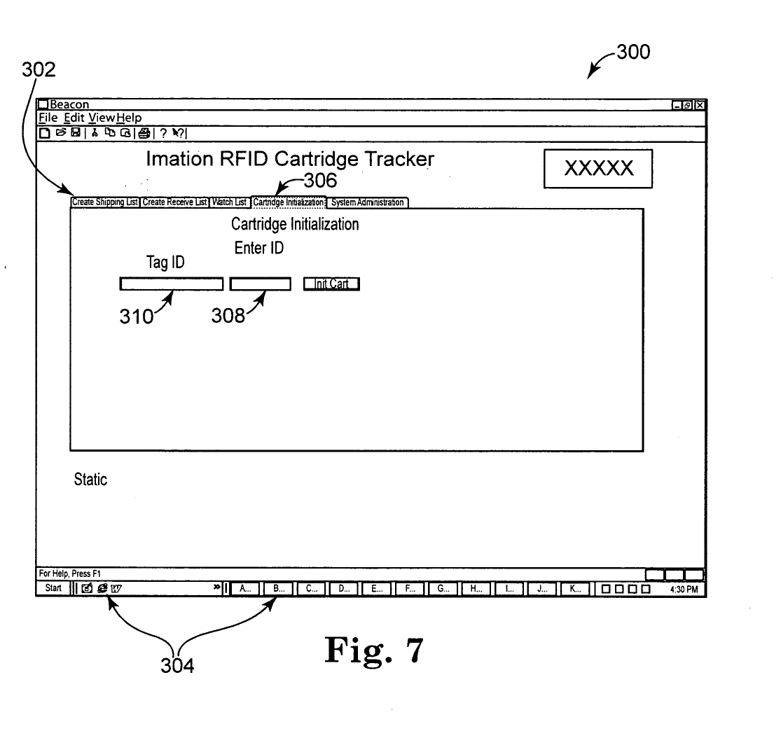

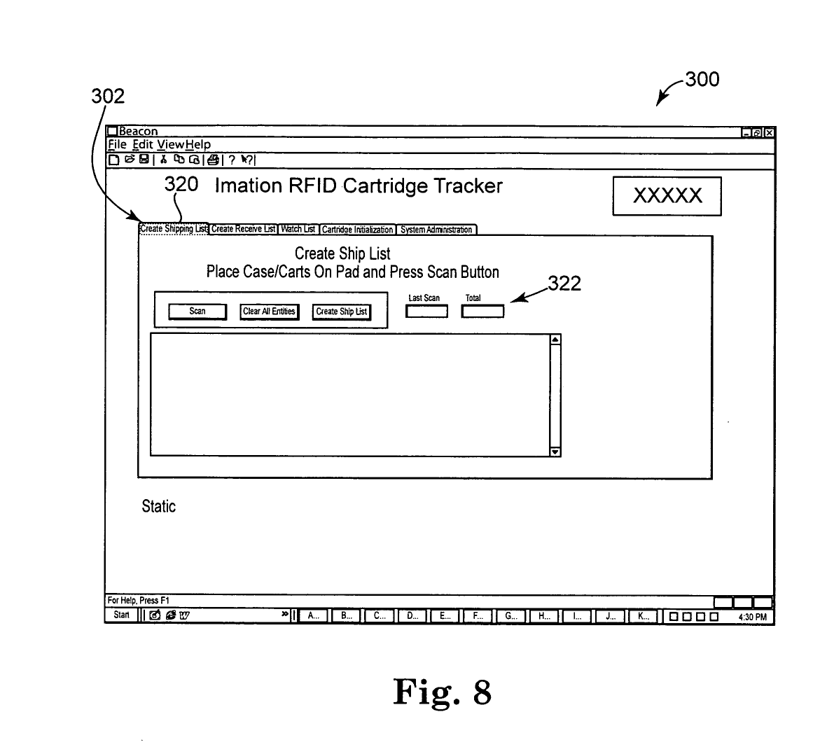

In one embodiment, the reader system 54 includes an antenna pad 62 having a pad antenna 62a (or antenna 62a) operably coupled to a reader unit 64 via a cable 65 and electrically coupled to a graphical user interface (GUI) 66. In one embodiment, the antenna pad 62 includes an impedance matching network (not shown, but internal to the pad 62) between the antenna 62a and the cable 65. In general, the pad antenna 62a is configured to generate an electromagnetic field that inductively powers the device RFID tag 60. The pad antenna 62a is sized/selected based upon balancing certain radiation limits that government entities place on such antennas with a desired/specified range for the pad antenna 62a in activating the device RFID tag 60, and with a convenient pad size. For example, the Federal Communications Commission (FCC) specifies a field limit for antenna output at 10 meters and 30 meters, and the pad antenna 62a is sized as described below to provide a read range for at least one data storage device 52, and preferably for multiple data storage devices 52, that complies with the FCC field limits. With this in mind, one embodiment of the pad antenna 62a provides a rectangular antenna 62a having an effective antenna area of about 370 mm by about 450 mm to provide a sufficient read field out to a furthermost edge of multiple data storage devices 52 that are placed adjacent to the pad antenna 62, as more fully described in FIG. 6

The reader unit 64 includes an enclosure 68 housing a transceiver, signal processor, controller, memory, power supply, and reader PC board (not shown) that are operable to read data from the device RFID tag 60 and transmit the data to the GUI 66. In this regard, in one embodiment the reader unit 64 is generally a transceiver and includes reader software having a library of calls and a source code that enables the contactless identification of objects. One example of suitable reader software includes software provided with a Feig Electronics RFID reader unit available from Feig Electronics, Weilburg, Germany. These and other suitable reader units are compatible and comply with ISO, EN, DIN standards. In general, the reader unit 64 is powered by an electrical connection 70, such as a 120 volt power cord, and includes an output connection 72, such as an Ethernet connection or a universal serial bus (USB) that couples to the GUI 66. Other power sources and output connectors are also acceptable.

The cable 65 is selected to have a length that desirably separates the reader unit 64 from the pad antenna 62a to minimize possible interference between the reader unit 64 and the antenna 62a. In an alternative embodiment, the reader unit 64 is integrated with the pad antenna 62a and the cable 65 is optional.

In one embodiment, the GUI 66 includes a memory unit 74 and a display unit 76. The data collected from the data storage device 52 by the reader unit 64 can be transmitted to the GUI 66 for data storage, data manipulation, and data appending in a variety of manners. For example, in one embodiment the GUI 66 records and sorts data collected from multiple such data storage devices 52 passing by the reader system 54. In another embodiment, the GUI 66 is operable to append data to the device RFID tag 60, including a volser number that might either be missing from the data storage device 52 or not yet initialized to the data storage device 52. In other embodiments, the GUI 66 is operable to append and record shipping information related to the transfer of the data storage device 52 as it leaves a user facility in transit to a storage facility, or as the data storage device 52 returns from a storage facility to the user facility.

In general, the GUI 66 operates on GUI software that is adapted to access the library of calls and the source code of the software of the reader unit 64 described above. In particular, in one embodiment the GUI software employs a code that communicates with the software of the reader unit 64 and enables a user of the GUI 66 to generate encrypted tag ID numbers and/or cyclic redundancy check values that are stored in the device RFID tag 60, as described in FIG. 3A below. With this in mind, in one embodiment the reader system 54 employs the software of the reader unit 64 to determine the identification of the device RFID tags 60 that are within range of the field generated by the pad antenna 62, and the GUI software is employed to read information, including encrypted information, between the device RFID tag 60 and the GUI 66.

For example, software of the reader unit 64 is employed to read information from the device RFID tag 60, and software of the GUI 66 accesses the information read by the software of the reader unit 64 and writes a file in extensible markup language (XML). The XML file is executed in a form that enables a user to customize the definition, transmission, validation, and/or interpretation of data within fields of the device RFID tag 60. The XML file is configured for sharing with a database via software operable by the GUI 66. In this manner, a user of the system 50 experiences seamless file sharing between the database software and the software of the GUI 66, which is useful in the tracing of the data storage device 52 via the device RFID tag 60. In one embodiment, the database software is a tape management software useful in collating information related to the shipment of data storage devices, for example, and the software of the GUI 66 is dynamically linked via an operating system of the GUI 66 to communicate with the tape management software, such that little or no user intervention is necessitated in the tracing of devices 52 via the system 50. In one embodiment, the XML file generated by the software of the GUI 66 is encrypted such that the definition, transmission, validation, and/or interpretation of data between the software of the GUI 66 and the database are secure.

The storing, sorting, and appending of data by the GUI 66 can include the user manipulation of a stylus 78 that interacts with the display unit 76. In this regard, the GUI 66 enables a user to view the data storage devices 52 that are traced, and view and manipulate the corresponding volser numbers of the data storage devices 52 that are sorted and traced between facilities. For example, in one embodiment the user employs the stylus 78 to select, sort, and input a desired disposition (destination or receipt location) of one or more devices 52 into display unit 76, the selection of which is stored and/or operated on by the memory unit 74 as assisted by the GUI software and ultimately communicated to a lookup/tracing database, for example via transmission over the Internet.

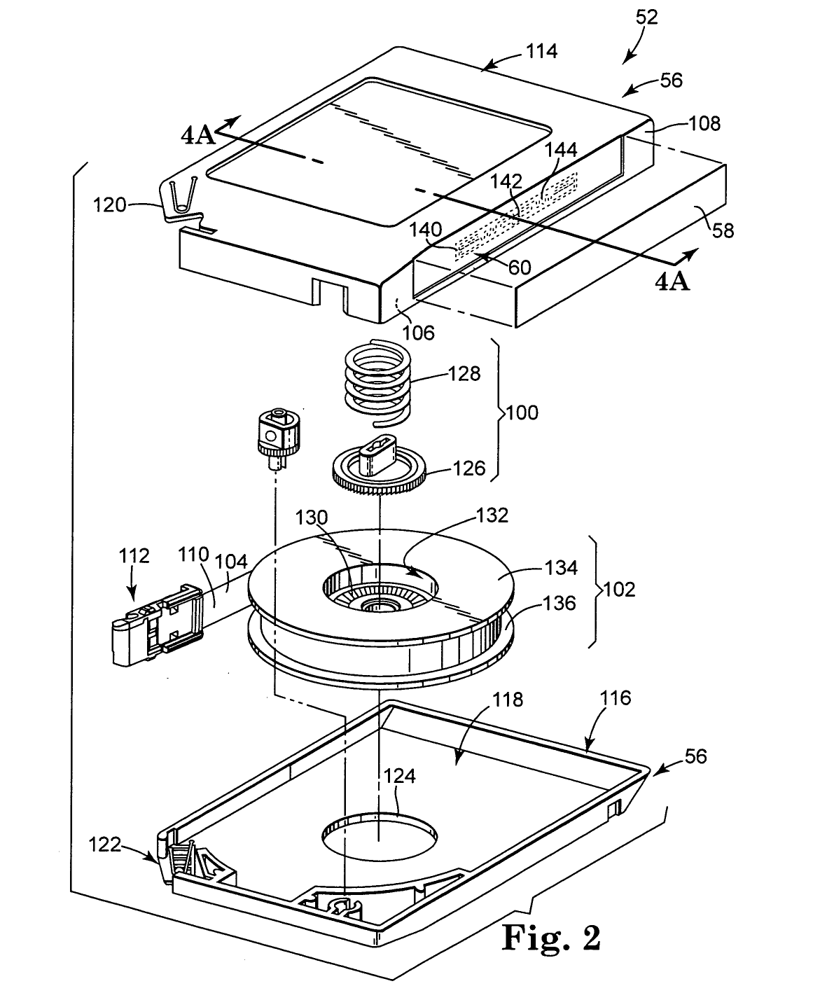

FIG. 2 illustrates an exploded view of the data storage device 52 according to one embodiment of the present invention. The data storage device 52 is illustrated as a single reel data storage tape cartridge, although it is to be understood that other forms of data storage devices are also acceptable, including data storage devices such as a micro hard drive, a hard disk drive, a quarter-inch cartridge, and scaleable linear recording cartridges to name but a few examples. Thus, the present invention is usefully employed with a variety of data storage devices, and the data storage device 52 illustrated is but one example.

Generally, the data storage device 52 includes the housing 56, a brake assembly 100, a tape reel assembly 102, and a storage tape 104. In one embodiment, the device RFID tag 60 is coupled to an interior surface 106 of the housing 56, and the optical label 58 is coupled to an exterior surface 108 of the housing 56. In this regard, although the optical label 58 is illustrated as coupled to a side of the housing 56, it is to be understood that the optical label 58 is coupleable to other portions of the exterior surface 108 of the housing 56, such as an end surface, for example. The tape reel assembly 102 is disposed within the housing 56. The storage tape 104, in turn, is wound about the tape reel assembly 102 and includes a leading end 110 attached to a leader block 112.

The housing 56 is sized for insertion into a typical tape drive (not shown). Thus, the housing 56 size is approximately 125 mm×110 mm×21 mm (having a volume of about 29 cm³), although other dimensions are equally acceptable. With this in mind, the housing 56 defines a first housing section 114 and a second housing section 116. In one embodiment, the first housing section 114 forms a cover, and the second housing section 116 forms a base. It is to be understood that directional terminology such as “cover,” “base,” “upper,” “lower,” “top,” “bottom,” etc., is employed throughout this specification to illustrate various examples, and is in no way intended to be limiting.

The first and second housing sections 114 and 116, respectively, are reciprocally mated to one another to form an enclosed region 118 and are generally rectangular, except for one corner 120 that is preferably angled to form a tape access window 122. The tape access window 122 forms an opening for the storage tape 104 to exit the housing 56 when the leader block 112 is removed from the tape access window 122 and threaded to a tape drive system (not shown) for read/write operations. Conversely, when the leader block 112 is stored in the tape access window 122, the tape access window 122 is covered.

In addition to forming a portion of the tape access window 122, the second housing section 116 also forms a central opening 124. The central opening 124 facilitates access to the tape reel assembly 102 by a drive chuck of the tape drive (neither shown). During use, the drive chuck enters the central opening 124 to disengage the brake assembly 100 prior to rotating the tape reel assembly 102 for access to the storage tape 104.

The brake assembly 100 is of a type known in the art and generally includes a brake body 126 and a spring 128 co-axially disposed within the tape reel assembly 102. When the data storage device 52 is idle, the brake assembly 100 is engaged with a brake interface 130 to selectively “lock” the tape reel assembly 102 to the housing 56.

The tape reel assembly 102 includes a hub 132, an upper flange 134, and a lower flange 136. The hub 132 defines a tape-winding surface (not visible in FIG. 2 due to the presence of the storage tape 104) about which the storage tape 104 is wound. The flanges 134, 136 are optional. For example, in one embodiment the storage tape 104 is wound about a flangeless hub such that the tape reel assembly 102 comprises only the flangeless hub. When the flanges 134, 136 are provided, they are coupled to opposing ends of the hub 132 and extend in a radial direction from the hub 132. It is desired that the flanges 134, 136 be spaced a distance apart that is slightly greater than a width of the storage tape 104. In this manner, the flanges 134, 136 are adapted to guide and collate the storage tape 104 as it is wound onto the hub 132.

The storage tape 104 is preferably a magnetic tape of a type commonly known in the art. For example, the storage tape 104 can be a balanced polyethylene naphthalate (PEN) based substrate or polyester substrate coated on one side with a layer of magnetic material dispersed within a suitable binder system, and coated on the other side with a conductive material dispersed within a suitable binder system. Acceptable magnetic tape is available, for example, from Imation Corp., of Oakdale, Minn.

The leader block 112 covers the tape access window 122 during storage of the data storage device 52 and facilitates retrieval of the storage tape 104 for read/write operations. In general terms, the leader block 112 is shaped to conform to the window 122 of the housing 56 and to cooperate with the tape drive (not shown) by providing a grasping surface for the tape drive to manipulate in delivering the storage tape 104 to the read/write head. In this regard, the leader block 112 can be replaced by other components, such as a dumb-bell shaped pin. Moreover, the leader block 112, or a similar component, can be eliminated entirely, as is the case with dual reel cartridge designs.

In one embodiment, a first pocket (not shown) is formed in the first housing section 114 and a second reciprocal and opposing pocket (not shown) is formed in the second housing section 116 such that upon assembly of the housing 56, the opposing pockets combine to form a cavity within the enclosed region 118 that is configured to retain the device RFID tag 60. In this regard, the device RFID tag 60 is coupled to the housing 56 by being retained within the cavity. In another embodiment, the device RFID tag 60 is adhesively attached directly to the interior surface 106 of the first housing section 114.

In one embodiment the device RFID tag 60 is a passive RFID tag and includes a backing 140, a silicon chip 142, and an antenna 144. The backing 140 is a substrate configured to retain the silicon chip 142 and the antenna 144. In this regard, the backing 140 is a carrier for the chip 142 and the antenna 144 components and in one embodiment is rigid and is referred to as a printed circuit board backing. For example, in one embodiment the backing 140 is a polyester backing to which two or more layers of a metal foil are adhered. The metal foils are etched to form a coiled antenna 144, a capacitor, and integrated circuit (IC) pads. Suitable connections are made between the foil layers, and an integrated circuit such as the chip 142 is attached and electrically connected to the IC pads employing, for example, an anisotropic conductive adhesive.

In an alternate embodiment, the backing 140 is a flexible film backing onto which the chip 142 and the antenna 144 components are laminated to one side prior to adhesively attaching an opposing side of the backing 140 to the interior surface 106 of housing 56. In addition, the backing 140 can include electrical features (such as pads, metal-plating holes, wire bonding, etc.) adapted to facilitate information transfer to/from the chip 142. In any regard, it is generally desirable to locate the antenna 144 relative to the housing 56 (FIG. 2) away from large metal components (such as baseplates) and equipment interference points to minimize mechanical and electrical interference of the device RFID tag 60 during read/write and handling of the device 52.

FIG. 3A illustrates a top view of one embodiment of the device RFID tag 60. The device RFID tag 60 includes circuitry 146 including the chip 142 and the antenna 144 printed on the backing 140. In one embodiment, the RFID tag 60 is an EPC class 1 RFID tag configured to be programmed and/or read by GUI software that is operated by the reader system 54 (FIG. 1). In a preferred embodiment, multiple RFID tags 60 can be individually and simultaneously identified (read or electrically recognized) by the reader system 54. In one embodiment, the RFID tag 60 is an ultra high frequency (UHF) tag. Other forms of the RFID tag 60 are also acceptable, such as high frequency (HF) tags.

FIG. 3B illustrates a top view of another embodiment of the device RFID tag 60. The device RFID tag 60 is a high frequency HF 13.56 MHz tag that includes circuitry 146′ having a capacitor 141′, a chip 142′ and an antenna 144′ printed on a backing 140′. One suitable HF tag is a 13.56 MHz ISO 15693 “vicinity” tag.

As a point of reference, when the device RFID tag 60 is a passive RFID tag, it does not employ its own power source. In this regard, the passive RFID tag is “powered” whenever access to the tag is initiated by the reader system 54 (FIG. 1). For example, when the reader unit 54 queries the RFID tag, an alternating current in the antenna pad 62 (FIG. 1) induces a current in the antenna 144 of the passive RFID tag. This magnetically induced current in the RFID tag enables the tag to send and/or receive data. With this in mind, in one embodiment the device RFID tag 60 is a passive RFID tag having a practical read range of less than approximately 6 feet (about 2 meters). The passive RFID tag preferably responds to a field less than 1 A/m. It preferably has a resonant frequency near 13.56 MHz when placed on the data storage device. To this end, in one embodiment the silicon chip 142 is a radio frequency memory chip and includes a radio frequency interface (not shown) to support a nearby, contactless access to/from the memory.

FIG. 3C illustrates a side view of the device RFID tag 60 of FIG. 3A according to one embodiment of the present invention. The circuitry 146 is generally printed or wired or disposed on the backing 140. In one embodiment, the silicon chip 142 projects out of the circuitry 146 and away from the backing 140 to define a prominence that is accommodated by a relief area of the first housing section 114, described below. In another embodiment, the chip 142 is disposed between the circuitry 146 and an optical label 148 that is placed over the circuitry 146. In another embodiment, the chip 142 is covered by a protective layer, such as a thin plastic sheet or a drop of encapsulant, to increase its resistance to physical or chemical damage.

In one embodiment, the device RFID tag 60 includes an optical label 148 coupled to the backing 140 opposite of the circuitry 146. The label 146 provides a continuous lateral area that is suited for printing a media identification field 143 alongside of a volser identification field 145. In this regard, in one embodiment the label 148 is a newly manufactured label that is printed with the media identification field 143 and the volser identification field 145 and is attached over the circuitry 146 of a new device RFID tag 60 during the manufacture of a new data storage device 52. In another embodiment, the label 148 is optional and the media identification field and the volser identification field are provided as a portion of a retrofitted optical label 58 (FIG. 2) that can be directly attached to the device RFID tag 60 or attached to the first housing section 114 in a region near the device RFID tag 60.

The RFID tag 60 includes the backing 140 or other substrate onto which is disposed circuitry 146 including the capacitor 141′, the silicon chip 142 and the antenna 144. In this regard, the circuitry 146, which includes the chip 142 and the antenna 144, is referred to as an inlay (or inlet) 146. In one embodiment, the backing 140 is a laminate having adhesive coated onto each of the opposing two sides. One adhesively coated side is configured for attachment to the housing 56 (FIG. 2), and the opposing adhesively coated side is suited for receiving the inlay 146. Other suitable forms for the backing 140 are also acceptable. When a printed label is attached over the inlay 146, the resulting structure is referred to as an RFID label.

The silicon chip 142 electronically records and/or stores device information and is not necessarily drawn to scale in FIGS. 2 and 3A-3C. In one embodiment, the silicon chip 142 is configured to store device information into a plurality of data fields. For example, in one embodiment, the silicon chip 142 is a memory chip capable of recording and/or storing device information, such as a format of data stored on the device 52 and a volser number associated with the device 52. In one embodiment, the memory of the silicon chip 142 stores a subset of data that is present on the optical label 58. In an alternative embodiment, the memory of the silicon chip 142 stores all data that is present on the optical label 58 and includes fields including a 64 bit unique TAG identifier, an 8 bit RFID revision level, an 88 bit user defined volser number, a 32 bit cyclic redundancy check (CRC) sum, a 160 bit manufacturer's serial number, a case and/or device identifying number, and other data fields. In another embodiment, the silicon chip 142 stores different field information for different forms of devices 52. To this end, the silicon chip 142 is preferably an electronic memory chip having at least the memory capacity to be written with device information. In one embodiment, the silicon chip 142 is an electronic memory chip capable of retaining stored data even in a power “off” condition, and is for example, a 4 k-byte electrically erasable programmable read-only memory (EEPROM) chip known as an EEPROM chip available from, for example, Philips Semiconductors, Eindhoven, The Netherlands. In another embodiment, the silicon chip 142 is a 1 k-byte EEPROM chip. Those with skill in the art of memory chips will recognize that other memory formats and sizes for the chip 142 are also acceptable.

The chip 142 is programmed to have a specific content and format for the information stored in memory. In one embodiment, the chip 142 electronically stores a subset of the data present on the optical label 58 (FIG. 2), such as the format of the device 52 and the volser number. In another embodiment, the chip 142 electronically stores multiple subsets of data including the 8 bit RFID revision field, the 88 bit user defined volser number, the 32 bit CRC sum that is derived from the tag ID and the RFID revision and the user defined volser number, an optional 160 bit manufacturer's serial number, and one or more optional user defined fields that enables selective user expansion of the data fields over time. In one embodiment, the 64 bit tag ID is pre-programmed by the chip manufacturer. In one embodiment, the RFID revision field specifies a revision level of the data stored on the chip 142, and also determines the format of the information that is read sequentially.

In one embodiment, the volser number is a unique number that is specific to each data storage device it is associated with. In another embodiment, the volser number is a non-unique number. The volser number can be user-defined or assigned by a manufacturer according to specifications provided by a customer. In general, the volser number includes a character within the 88 bit field to mark the end of the volser number, which enables the reading and interpretation of variable length and/or unique volser numbers. In one embodiment, the end mark character is a NULL character, for example 8 bits of all binary zeros. As a point of reference, 8 bits of all binary zeros is the initial state of the memory, and also corresponds with a string termination character in the program language C/C++. In one embodiment, the bit pattern of the volser number is not encrypted when reading or writing the volser number to enable easy decoding by an outside source, such as a customer or client. In other embodiments, the volser number is encrypted (for example by inverting the bits) to prevent decoding by an outside source, or encoded to save space in the memory of the chip 142.

The CRC is a 32 bit field derived from the tag ID, the RFID revision, and the volser number. In one embodiment, the CRC is form of a hash function that is employed to produce a check value against a block of data, such as a packet of network traffic or a block of a computer file. In this regard, a check value is a small, fixed number of bits that can be employed to detect errors after transmission or storage of data. For example, in one embodiment the CRC is computed and appended before transmission or storage, and verified afterwards by a recipient to confirm that no changes occurred on transmission of the data. Advantages of CRCs are that they are easily implemented in binary hardware, they can be analyzed mathematically, and CRCs detect common errors caused by noise in transmission channels.

The CRC value is the remainder of a binary division that has no bit carry in the message bit stream, by a pre-defined and preferably short bit stream having a length n, where n represents a coefficient of a polynomial. Generally, CRCs are derived from the division of a polynomial, such as a ring of polynomial, over a finite field. In this regard, the set of polynomials is chosen such that each coefficient is either 0 or 1 (which is a fundamental of a binary or base 2 number). In an exemplary embodiment, the generating polynomial of the CRC is chosen to be:

x̂=+x̂26+x̂23+x̂22+x̂16+x̂12+x̂11+x̂10+x̂+x̂7+x̂5+x̂+x̂2+x̂+x̂0

and a seed value is selected to be 0xFFFFFFFF. In this manner, the CRC enables the determination if one or more of the tag ID, the RFID revision, or the volser number have become corrupted or incorrectly read during transmission.

In other embodiments, a checksum, parity check, or other function may be employed to generate the check value for the data. A checksum usually refers to a check value that is a sum of the data being checked. A parity check usually refers to a check value that is the exclusive-or of the data being checked. The set of functions useful in generating such check values are referred to as hash functions.

In one embodiment, the antenna 144 is a coiled copper radio frequency (RF) antenna. In an alternate embodiment, the antenna 144 is integrated within the chip 142. In any regard, it is to be understood that other materials for, and various forms of, the antenna 144 are also acceptable. In general, the antenna 144 is configured to inductively couple with the reader system 54 (FIG. 1) in receiving/sending data. With this in mind, in one embodiment the antenna 144 is an RF antenna configured to communicate information stored on the chip 142 to a transceiver module (not shown) in the reader unit 64 (FIG. 1).

In one embodiment, the device RFID tag 60 is employed in a 13.56 MHz RFID system and the antenna 144 has a reactance that produces a resonance of about 13.56 MHz. In this regard, for RFID circuits having a capacitance of 27 pF, the antenna coil and parallel capacitor have a reactance of about +j435 ohms, equivalent to an inductance of about 5.1 μH. Other IC capacitances require different antenna reactances to resonate at 13.56 MHz. To this end, other capacitances and antenna reactances for the device RFID tag 60 are also acceptable. In one embodiment, the antenna 144 has a capacitance that is adjustable to tune the resident frequency. In another embodiment, the capacitance of the antenna 144 is laser trimmed.

It is desired that the device RFID tag 60 be sized to fit within a perimeter of the optical label 58 (FIG. 2), and be sized to have an appropriate range for the antenna pads 62 (FIG. 1). In this regard, in one embodiment the circuitry 146 is optimally sized to be disposed within a boundary of the backing 140, and defines a width of W and a length L that approximates a perimeter of the antenna 144. The circuitry width W and the circuitry length L are sized and selected according to the size of the data storage device to which they are attached. With this in mind, an exemplary width W is between about 5 mm-20 mm, and an exemplary length L is between about 50 mm-100 mm. One of skill in the art will recognize that the width W and the length L for the circuitry 146, and thus the antenna 144, is adjustable in order to provide a suitable read range between the system 50 (FIG. 1) and the device RFID tag 60. For coiled antennas used in high frequency tags, the larger the area of the coil the larger the potential read range.

For example, one aspect of the invention provides the data storage device 52 as a data storage tape cartridge and the antenna 144 within the circuitry 146 is selected to have a width W of about 15 mm and a length L of about 77 mm, resulting in an antenna area of about 1155 sq. mm. In this manner, the antenna 144 is provided with a sufficient range, while the device RFID tag 60 is sized to fit beneath the optical label 58 (FIG. 2). In another exemplary embodiment, the antenna 144 is sized to have a width W of about 15 mm and a length L of about 62 mm, resulting in an antenna area of about 930 sq. mm. In other embodiments, the antenna 144 is sized to have a width W of about 8.8 mm and a length L of about 70 mm and has an antenna area of about 616 sq. mm, which is suited for attachment to devices having slim profiles. In yet another embodiment, the antenna 144 is sized to have a width W of about 15 mm and a length L of about 77 mm. The antenna dimensions set forth above are exemplary dimensions, as other antenna dimensions are also acceptable. Generally, the width W and the length L of the circuitry 146 are sized such that the antenna 144 is about 1 mm less in width and about 2 mm less in length in comparison to dimensions of the smallest backing 140 and label that is sized to cover the backing 140.

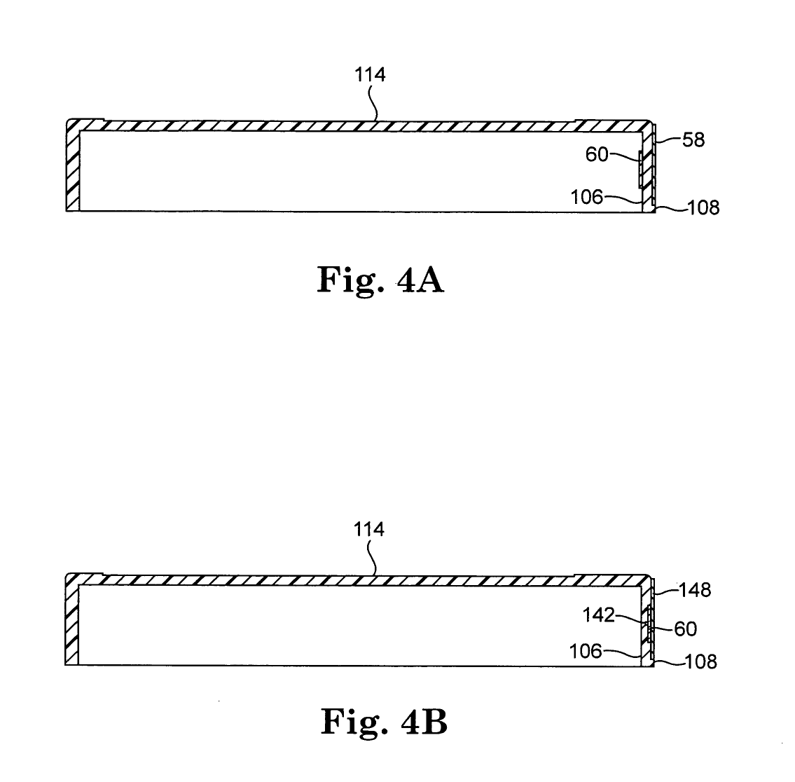

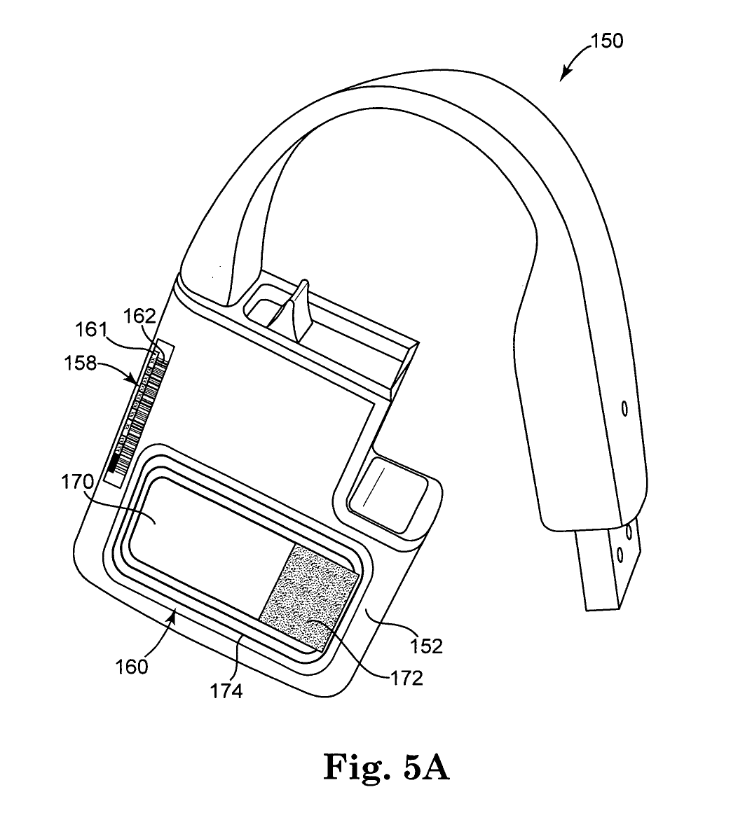

FIG. 4A illustrates a cross-sectional view of the first housing section 114 showing one configuration for locating the device RFID tag 60 relative to the first housing section 114. In one embodiment, the data storage device 52 (FIG. 2) is newly manufactured to include the device RFID tag 60 on the interior surface 106 of the first housing section 114, and the optical label 58 is secured to the exterior surface 108 of the first housing section 114. In this manner, the device RFID tag 60 is located inside of the first housing section 114, and thus located away from potential wear and handling points present on the exterior surface 108 of the first housing section 114. During a manufacturing step, the device RFID tag 60 is programmed to include at least a subset of the data that is printed on the optical label 58. In particular, the device RFID tag 60 is preferably electronically programmed to include at least the volser data that is printed on the optical label 58.

FIG. 4B illustrates a cross-sectional view of the first housing section 114 showing another “retrofit” configuration for locating the device RFID tag 60 relative to the first housing section 114. During a post-manufactured retrofit, or an upgrade of the data storage device 52 (FIG. 2), it can be desirable to replace an existing or damaged optical label with an improved set of identifiers. After removing the damaged or outdated optical label, the device RFID tag 60 is secured to the exterior surface 108 of the first housing section 114 and a new optical label 148 is disposed over the device RFID tag 60. Again, it is desirable that the device RFID tag 60 include at least a subset, and in particulars at least the volser number, of the data that is printed on the optical label 148.

With additional reference to FIG. 2, in one embodiment the exterior surface 108 of the first housing section 114 is provided with an integrally molded label relief that defines a cavity sized to receive the chip 142 of the device RFID tag 60. The integrally molded label relief preferably provides an exit path for the mold components to be removed relative to the first housing section 114 after the molding step, and in this regard, is molded to be a “three-sided” label relief that is sized to accept a perimeter of the optical label 148.

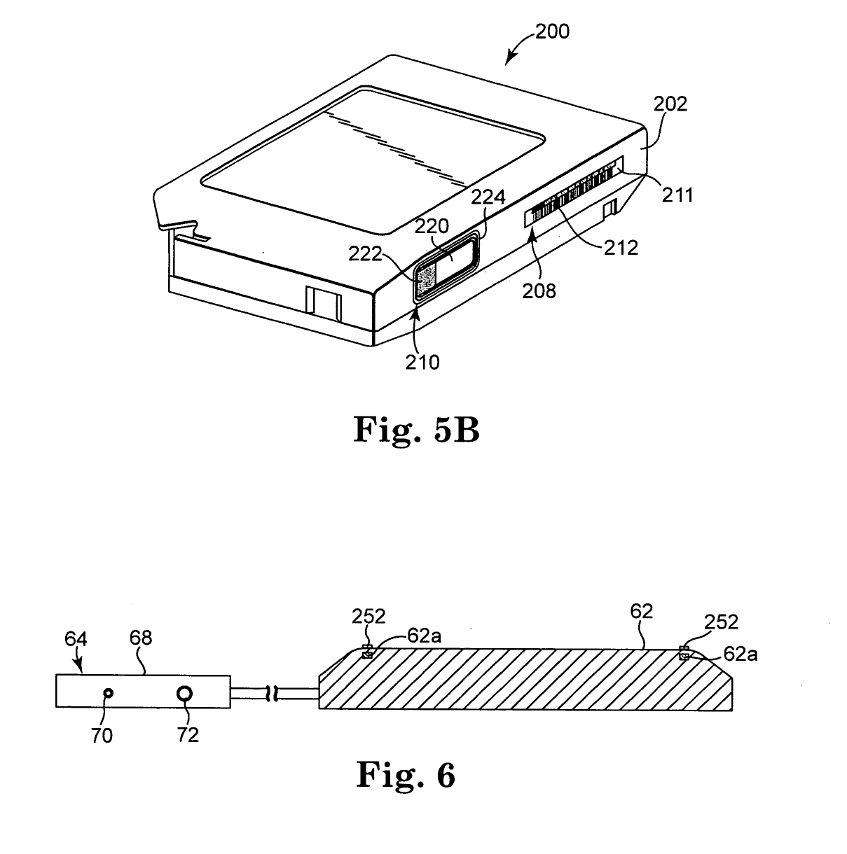

Aspects of the present application can be broadly applied to any manner or style of data storage device, and is not limited to the data storage tape cartridge illustrated in FIG. 2. For example, FIG. 5A illustrates a perspective view of a data storage device 150 according to another embodiment of the present invention. The data storage device 150 provides an example of a micro hard drive including a housing 152 having an optical label 158 and a device RFID tag 160 coupled to the housing 152. In one embodiment, the optical label 158 includes a bar code having various data fields including a media number field 161 and a volser number field 162.

In one embodiment, the device RFID 160 includes a backing 170, a silicon chip 172, and an antenna 174. The backing 170 is highly similar to the backing 140 (FIG. 2) and defines a substrate that is configured to retain the silicon chip 172 and the antenna 174. It is to be understood that a superstrate (not shown) would typically be provided to cover the device RFID tag 160 such that the silicon chip 172 and the antenna 174 would not necessarily be visible. In addition, although the optical label 158 and the device RFID tag 160 are illustrated as positioned on an exterior of the housing 152, it is to be understood that these structures could be placed anywhere on the housing 152. For example, in one embodiment the device RFID tag 160 is integrated to a position within the housing 152. In any regard, the data storage device 150 includes at least a volser number printed in the volser number field 162 on the optical label 158 and an identical electronically stored volser number in the silicon chip 172, such that the reader system 54 (FIG. 1) is configured to read the volser number and trace the data storage device 150 entering/exiting the antenna pad 62 (FIG. 1).

FIG. 5B illustrates a perspective view of a data storage device 200 according to another embodiment of the present invention. The data storage device 200 provides an example of a micro hard drive including a housing 202 having an optical label 208 and a device RFID tag 210 coupled to the housing 202. In one embodiment, the optical label 208 includes a bar code printed with at least a media number field 211 and a volser number field 212, and the device RFID 210 includes a backing 220, a silicon chip 222, and an antenna 224. In one embodiment, the device RFID tag 210 is located where an optical label is typically placed on such a device, and could be covered by the optical label 208, for example.

The backing 220 is highly similar to the backing 140 (FIG. 2) and defines a substrate that is configured to retain the silicon chip 222 and the antenna 224. It is to be understood that a superstrate (not shown) would typically be provided to cover the device RFID tag 210 such that the silicon chip 222 and the antenna 224 would not necessarily be visible. In addition, although the optical label 208 and the device RFID tag 210 are illustrated as positioned on an exterior of the housing 202, it is to be understood that these structures could be placed anywhere on the housing 202. For example, in one embodiment the device RFID tag 210 is integrated to a position within the housing 202. In any regard, the data storage device 200 includes at least a volser number printed on in the volser number field 212 of the optical label 208 and an identical electronically stored volser number in the silicon chip 222, such that the reader system 54 (FIG. 1) is configured to read the volser number and trace the data storage device 200 entering/exiting the antenna pad 62 (FIG. 1).

In one embodiment, the data storage device 200 is a 2.5 inch SATA hard disk drive and the housing 202 substantially replicates a tape cartridge. In this manner, the data storage device 200 conforms to industry standard tape cartridges, and is compatible with existing tape automation equipment and software. In one embodiment, the data storage device 200 is a sealed, anti-static hard disk drive cartridge having a form factor that is suited for library cases, racks, and like manner of cartridge carousels.

FIG. 6 illustrates a cross-sectional view of the pad antenna 62a showing the reader unit 64 in the background. In one embodiment, the pad antenna 62a includes an embedded rectangular copper antenna 62a and an alignment guide 252 disposed about a perimeter of the antenna 62a. In general, it is preferred that the antenna 62a is larger than a perimeter of the data storage device 52, or a set of multiple data storage devices 52 within a container configured for placement on the antenna pad 62. The alignment guide 252 is provided to ensure that the container is placed on the pad antenna 62a such that the data storage device(s) 52 are within a field of the antenna 62a. To this end, in one embodiment the alignment guide 252 is integrally molded on the antenna pad 62 such that a periphery of the alignment guide 252 approximately centers the device RFID tags 60 within a field of the antenna 62a. In an alternative embodiment, the alignment guide 252 is printed indicia (i.e., a decal) that guides placement of the data storage device(s) 52 relative to the pad antenna 62. In this regard, in one embodiment the antenna 62a is disposed over an area of about 440 mm by 550 mm to provide a maximum field out to a furthermost edge of the alignment guide 252 and the data storage device(s) 52 in contact with the pad antenna 62.

In some embodiments, multiple pad antennas 62 are disposed in a row in order to ensure that the fields generated by the antenna 62a is larger than a perimeter of the data storage device 52, or a carton of multiple data storage devices, that is placed on the pad antenna 62. In other embodiments, two antenna pads 62 are oriented orthogonally one to the other such that the field generated by the antennas 62a intersects in a perpendicular manner to ensure that any random orientation of the device RFID tag 60 is readable. Although not shown, scanners/multiplexers and power splitters may be used to connect multiple antennas to a reader.

FIG. 7 illustrates a program 300 operable with the reader system 54 (FIG. 1) according to one embodiment of the present invention. The program 300 includes a menu 302 including a plurality of user selected functions, and a program list 304. In one embodiment, the menu 302 provides applications that create and compile lists that enable a user to trace the whereabouts of the data storage device(s) 52 (FIG. 1). The program list 304 identifies multiple other programs that are configured to electronically communicate with the program 300 in sharing and transferring of data files between users and/or facilities.

In general, and with additional reference to FIG. 1, the program 300 communicates through the software operable by the reader unit 64 and the GUI software operable by the GUI 66. The program 300 is adapted to read one or more data storage devices 52, create a report relative to the data storage devices 52 that have been read, compile a report, and verify that the data storage devices 52 are in transit (are being traced). In one embodiment, the program 300 is operable to electronically verify, for example by e-mail, that the transported data storage device(s) 52 have been received at a terminus end. In this manner, the creation of a report, the compilation of a report, and the verification of the transit enable the useful tracing of one or more data storage devices 52 between a starting location, such as a business office for example, and a terminating location, such as a storage facility.

In one embodiment, the menu 302 includes a cartridge initialization tab 306 that is configured to identify and initialize a new cartridge entering the reader system 54. A user activating the tab 306 is prompted to enter an ID in field 308. In one embodiment, the ID entered in field 308 is a volser number generated by the user that is to be assigned to the data storage device 52, and in particular, to the device RFID tag 60 attached to the device 52. In other embodiments, a sorted table of label serial numbers and corresponding volser numbers associated with multiple data storage devices 52 is stored on a mass storage device within memory unit 74, and the reader system 54 is operable to enter a suitable corresponding volser number for a selected one of the devices 52 into the ID field 308. In a similar manner, a tag ID for a selected one of the devices 52 can be either scanned or entered into field 310. Once initialized, the data storage device 52 is usable to store data and is configured for tracing via the system 50.

FIG. 8 illustrates the program 300 employed to create a shipping list of one or more data storage devices 52. With reference to FIG. 1, the menu 302 has been accessed by the user and a shipping list tab 320 is selected that creates a drop down menu 322. The shipping list tab 320 prompts a user to place one or more data storage devices 52 onto the antenna pad 62 and initiate the reader system 54 to scan all of the placed data storage devices 52 at once. The reader system 54 scans the entirety of the device RFID tags 60 within its field and automatically identifies all of the recognized data storage devices 52 in a listing of the drop down menu 322. In this manner, the graphical user interface 66 enables a user to scan and create a shipping list of one or more data storage devices 52. One embodiment of the drop down menu 322 prompts the user if one or more of the data storage devices 52 has been incorrectly read, or not read, by the reader system 54. The user can manually enter the unread data or scan the unread devices 52 with a handheld scanner, for example.

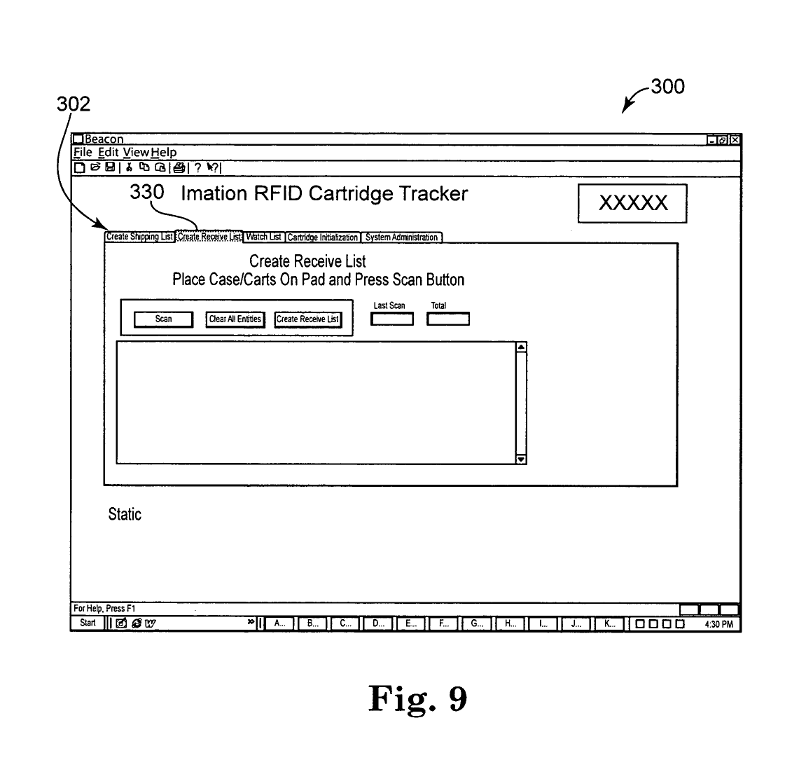

FIG. 9 illustrates the program 300 employed to identify one or more data storage devices as they are received in a facility. In this aspect of the program 300, the menu 302 is accessed by the user to create a receive list 330. One or more data storage devices 52 entering into a facility are placed on the pad antenna 62a and the program 300 is used to automatically scan the arrival of the data storage devices 52. The reader unit 64 recognizes/reads the volser number of each scanned device 52 and generates a raw list of scanned devices 52. The GUI 66 generates a receive list 330 of devices 52 that have been received on the pad antenna 62. In one embodiment, the receive list generated by the GUI 66 is an XML formatted list. In this manner, the reader system 54 is operable to trace one or more data storage devices as they are received at a facility, such as when multiple data storage devices are retrieved from storage and brought back to headquarters or another business location.

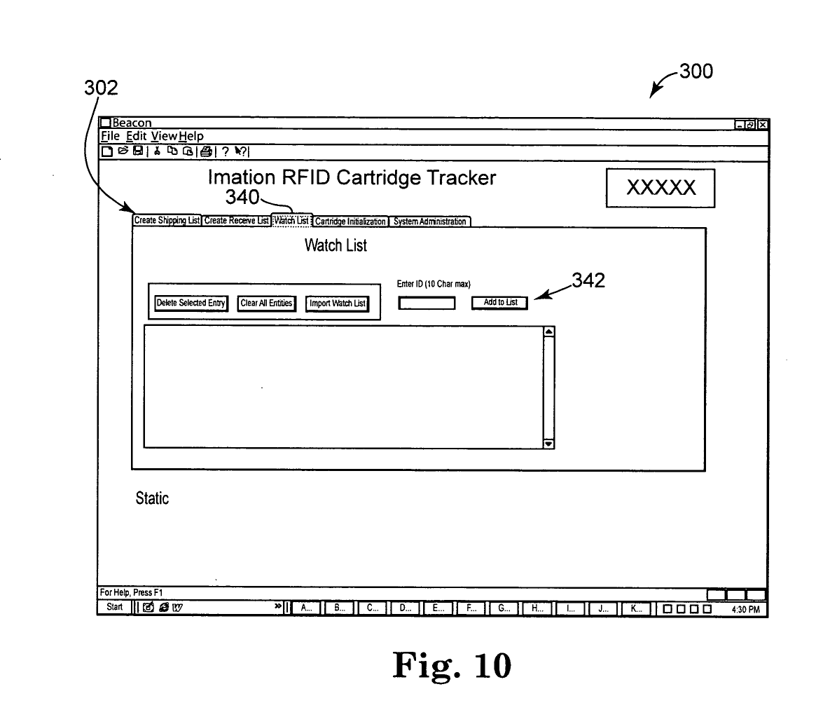

FIG. 10 illustrates the program 300 employed to create a watch list 340 for one or more data storage devices traced by the system 50. The watch list 340 can be updated based upon user preferences and enables a user to watch for one or more data storage devices 52 as they are traced via the system 50. For example, in one embodiment, the user enters a volser number of a device 52 of interest into the field 342, and the program 300 is operable to notify the user when the device 52 having the volser number of interest enters/exits within range of the pad antenna 62. In this manner, as a data storage device 52 arrives or exits pad antenna 62, the user is notified by the program 300 of the presence of that particular data storage device 52. Similarly, the watch list 340 is operable to seek multiple data storage devices 52 transiting the system 50.

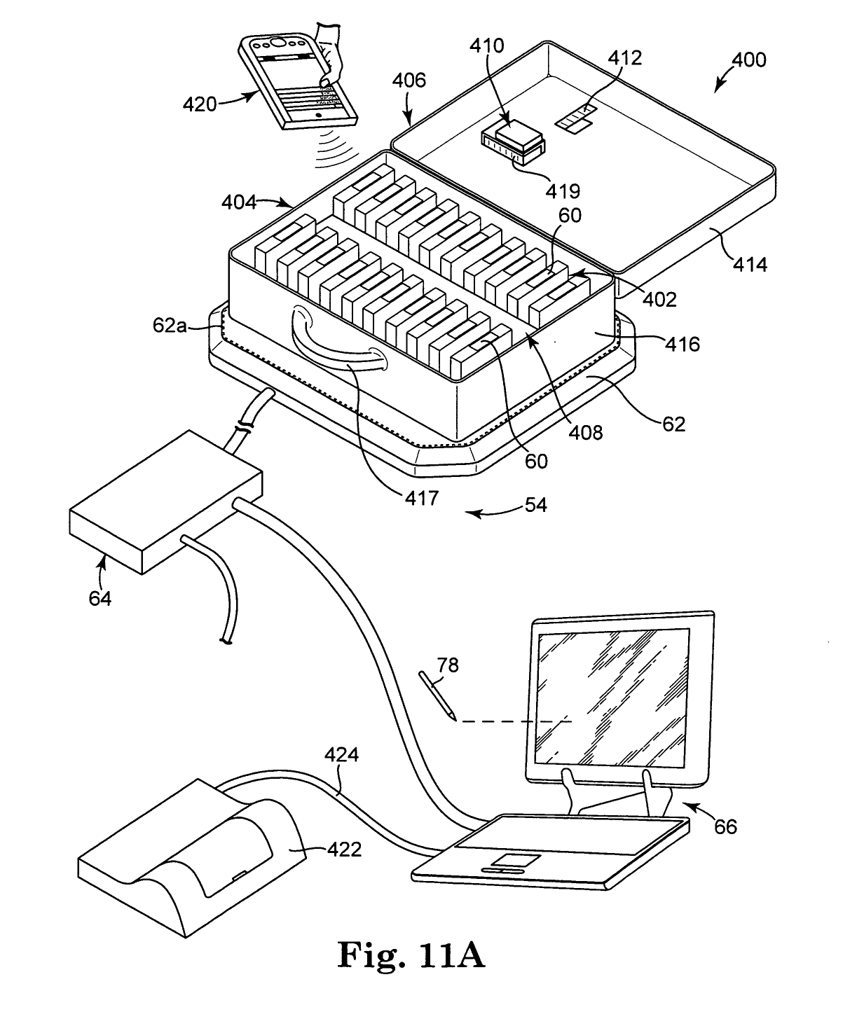

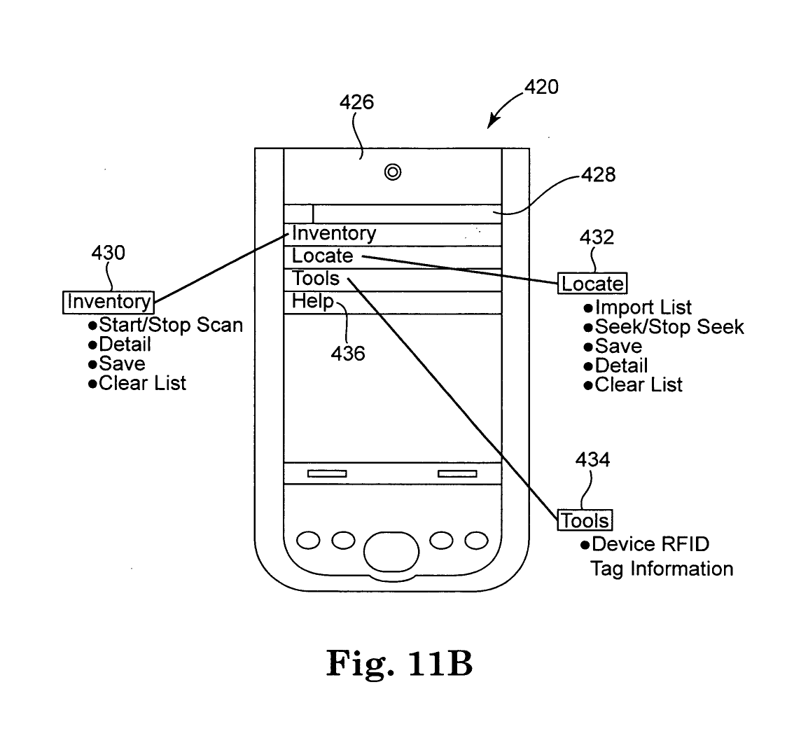

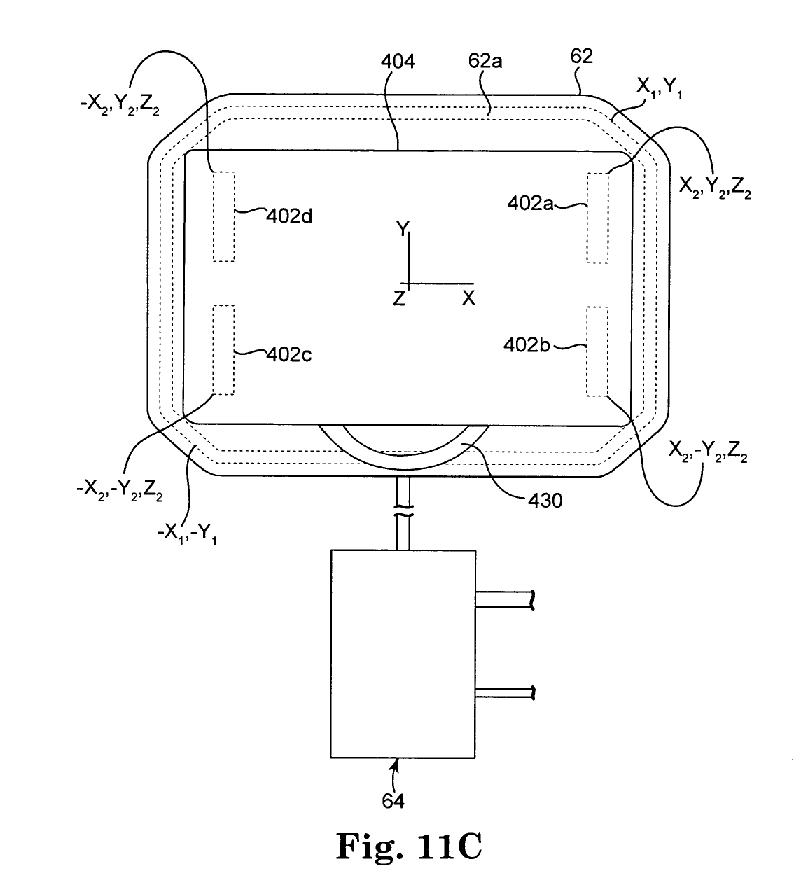

FIG. 11A illustrates a perspective view of an electronic data storage device tracing and tracking system 400 according to another embodiment of the present invention. The tracing and tracking system 400 includes multiple data storage devices 402 maintained within a case 404, where the reader system 54 is configured to trace and read an entirety of the device RFID tags 60 associated with the multiple data storage devices 402 in one pass of the case 404 across the field of the pad antenna 62.

In one embodiment, the case 404 defines an enclosure 406 provided with an insert 408, a global positioning system (GPS) unit 410 coupled to the enclosure 406 that enables tracking of the case 404 and the devices 402, and a case RFID tag 412 coupled to the enclosure 406. In one embodiment, the case 404 includes a first section 414 and a second section 416, where the first section 414 is a cover and the second section 416 is a base. The cover 414 includes the tracking GPS unit 410 and the case RFID tag 412 coupled to the cover 414. In this regard, the cover 414 is illustrated in an open position to provide a better view of the multiple data storage devices 402 in the base 416, although it is to be understood that tracing and tracking of the devices 402 is preferably accomplished by maintaining the cover 414 in the closed position.

In one embodiment, the case 404 is a molded case of a durable plastic resin and includes the cover 414 movably coupled to the base 416, and a carrying handle 417 coupled to the base 416. In general, the case 404 is sized to accommodate multiple data storage devices 402. In one embodiment, each data storage device 402 occupies a volume of about 29 cm³ and the case 404 is sized to contain about twenty such devices 402 within the enclosure 406. The case 404 can be molded from any suitable engineering plastic, such as polyester, polycarbonate, high density polyethylene, and the like. One suitable case 404 is molded from Lexan™ HPX polycarbonate resin, available from GE Advanced Materials, Fairfield, Conn. Suitable cases 404 are available from Hardigg, South Deerfield, Mass., and are identified as STORM CASE®.

The insert 408 is removably formed within the base 416 and is preferably a molded plastic insert configured to retain each of the multiple data storage devices 402 in a manner that orients the device RFID tags 60 perpendicular to the field generated by the pad antenna 62, which enables the reader system 54 to quickly and accurately read the multiple device RFID tags 60. In this regard, it is desired that the base insert 408 not interfere with the radiofrequency reading of the device RFID tags 60 attached to the devices 402. In one embodiment, the insert 404 includes multiple layers of cubed foam that can be customized to accommodate one or more data storage devices 402. In another embodiment, the insert 408 is a molded plastic insert, formed from suitable polymers such as polyolefins and the like, or other plastics. In this regard, the insert 408 can be either a rigid insert or a compliant insert.

The GPS unit 410 is a suitable global positioning system including cellular telephony technology that enables digital communication between the system 50 (FIG. 1) and the case 404 in which the GPS unit 410 is located. One suitable GPS unit 410 is available from, for example, Magellan, San Dimas, Calif. and is modified to included cell phone satellite tracking technology (i.e., the GPS unit includes cell phone circuitry). In one embodiment, the GPS unit 410 includes a GPS RFID tag 419 that is similar to the device RFID tag 60 (FIG. 3A) and is configured to communicate with the reader unit 64 (FIG. 1). In this manner, when the GPS RFID tag 419 (which is attached to the GPS unit 410, which is preferably located inside the case 404) is present on or near the antenna pad 62, the GPS RFID tag 419 is activated to an “on” state, which activates the cellular telephone satellite tracking function of the GPS unit 410 to enable global position tracking of the case 404 and the data storage devices 402 inside the case 404. During periods in which the case 404 is in storage, the GPS unit 410 is maintained in an “off” state to preserve battery life, and is selectively turned to the on state as the GPS RFID tag 419 (and the GPS unit 410 to which it is attached) passes over the antenna pad 62.

The case RFID tag 412 is similar to the device RFID tag 60 (FIG. 3A). In this regard, the case RFID tag 412 includes multiple electronic memory data fields stored on an electronic chip. In one embodiment, the case RFID tag 412 stores an identifier within its memory that associates that particular case RFID tag 412 with the case 404 to which it is attached. In this manner, the software of the GUI 66 (FIG. 1) is configured to associate a particular case 404 with specific data storage devices 402 stored within the case 404. In an alternative embodiment, the case RFID tag 412 electronically stores data fields that include data for the volser numbers of the multiple data storage devices 402, or other data indicative of the identity and disposition of the devices 402. By the embodiments above, one or more or all of the data storage devices 402 are traceably associated with the case 404 to which the case RFID tag 412 corresponds. The case RFID tag 412 can include data related to source of origin of the case 404, identifiers of the contents of the case 404, identifiers for the devices 402 in the case 404, and other data useful in tracing the devices 402 and the case 404. Since the case 404 is larger than the devices 402 stored within the case 404, the case RFID tag 412 can be sized to be larger than the device RFID tag 60, which enables easier and more reliable reading of the case RFID tag 412 with a handheld reader, for example. The case RFID tag 412 can be placed anywhere on the case 404, although it is preferred that the case RFID tag 412 be placed within the case 404. In one embodiment, the location of the case RFID tag 412 within the case 404 is identified on an exterior of the case 404, with a mark or other indicia, for example.

In one embodiment, the tracing and tracking system 400 includes an optional portable reader device 420 configured to read one or both of the optical tag 58 (FIG. 2) and/or the device RFID tag 60. In one embodiment, the portable reader device 420 is an optical reader device. In another embodiment, the portable reader device 420 is an RFID reader transceiver. In other embodiments, the portable reader device 420 is a handheld personal data assistant (PDA) 420 provided with a docking cradle 422 and a synchronization cable 424 suited for downloading and/or transmitting data between the PDA 420 docked in the cradle 422 and the GUI 66. In some circumstances, the volser number (described above) is corrupted or otherwise unreadable, and the portable reader device 420 is provided to enable a user to directly interrogate the optical label 58 to determine the volser number corresponding to one or more of the data storage devices 402. In this regard, in one embodiment the portable reader 420 is also configured to write a suitable volser number to one or more of the data storage devices 402.

As a point of reference, in some circumstances the case 404 is a metallic case that interferes with the sending and receiving of radio frequency signals within the reader system 54. To this end, in one embodiment the case 404 includes the cover 414 that can be opened to expose the optical label 58 and the device RFID tag 60 on the multiple data storage devices 402 for direct reading by the portable reader 420. In a preferred embodiment, the case 404 is a plastic case that is configured to enable the reader system 54 to read the identity of the multiple data storage devices 402 within the case 404 without having to open the cover 414.

FIG. 11B illustrates a front view of the PDA 420 operating application software that transfers information between the device RFID tags 60 (FIG. 11A) and the GUI 66 (FIG. 11A). In one embodiment, the PDA 420 includes an RFID card (not shown) and a secure digital input/output slot 426. One suitable RFID card is available from Wireless Dynamics, Inc., Calgary, Alberta, Canada and is identified as SDID 1020 RFID card. In general, the PDA 420 employs user commands to operate application software to start and stop RFID scanning activity. For example, while the PDA 420 is scanning, a user passes the inserted RFID card over the device RFID tags 60 to collect and scan information. Such collected information may then be examined in detail, or saved to a file. In this regard, during scanning the swipe speed of the PDA 420 over the devices 402 (FIG. 11A) ranges from about one cartridge every two seconds to about ten cartridges per second, although other swipe speeds are also acceptable.

The PDA 420 includes a variety of personal digital assistants operable with Windows Mobile 5.0 software or higher. One suitable PDA includes Dell Axim X51v available from www.dell.com.

The application software operable by the PDA 420 is designed to work in the environment described above in reading and writing to the device RFID tags 60. The PDA 420 includes a status line 428 that is visible throughout the session when accessing the dialog tabs. A variety of dialog tabs are provided including an inventory tab 430, a locate tab 432, a tools tab 434, and a help tab 436.

The inventory tab 430 includes controls that are employed to support performing a device inventory and includes a listbox that stores the volser numbers of scanned devices and a series of command buttons. The series of command buttons includes a start/stop scan button that is employed to place the device RFID tag 60 into and out of a scanning mode. When scanning, volser numbers of located devices 402 are inserted into the listbox. If the device RFID tag 60 information is validated (for example via the CRC check described above), the volser number is prominently displayed. If the device RFID tag 60 information is not validated, a flag is displayed, such as the volser number being displayed in red text. A text message can be displayed beneath the listbox for documenting a count of how many devices have been scanned.

The detail command button is employed to display a modal dialog containing detailed information related to the volser number currently selected in the listbox. For example, such information can include the unique tag identifier, the revision number, the volser number, and the CRC described above.

The save command button can be employed to save information on scanned devices. In one embodiment, the information is saved in encrypted format. Tapping the save command button will bring up a modal dialog box in which save options are presented prior to the actual creation of a saved file.

The clear list button will clear information from the listbox.

The locate tab 432 is employed to locate devices from an imported watch list. As with the inventory tab 430, accessing the locate tab 432 provides a listbox with volser numbers of the as-identified watch list items and a series of command buttons. The series of command buttons includes an import list button that is useful to bring up a file selection dialog, where the selected file contains a list of volser numbers in a predefined format. Volser numbers are read from the file, and inserted into the list box in text.

The seek/stop seek command button is employed to engage the scan card between an in-scan mode and an out of scan mode. While scanning, if a device in the watch list is detected, the volser number in the listbox is changed to a green color, for example, to indicate that the watched-for device 402 has been located. A text box beneath the listbox contains a count of matching or matched devices.

The save button enables a user to save the results of the locate operation to a file. Tapping this button will present a modal dialog in which save options are specified prior to the actual creation of a saved file.

The detail and clear list buttons have the same function on the locate tab 432 as on the inventory tab 430.

The tools tab 434 is employed to access diagnostic utilities of the PDA 420. In one embodiment, a card information button is toggled to display a modal dialog regarding information on the device RFID tag 60 or the SD card.

The help tab 436 stores information on the software version and support information. In one embodiment, the help tab 436 is non-interactive.

In one embodiment, moving files from the PDA 420 to the GUI 66 employs synchronization software that is best accessed when the PDA 420 is docked in the cradle 422 (FIG. 11A).

FIG. 11C illustrates a simplified top view of the case 404 containing the cartridges 402 positioned on the antenna pad 62. The simplified view illustrates four data storage devices 402a, 402b, 402c, 402d that are disposed in peripheral corners of the case 404. In this regard, the data storage devices 402a-402d are positioned at an outermost extent within the case 404 (and thus, the farthest distance from a center of the antenna 62a), which presents a challenge to the antenna 62a in reading the device RFID tags 60 (FIG. 11A) affixed to each of the devices 402.

With this in mind, an X-Y-Z coordinate system is imposed on the antenna pad 62 near an approximate center of the antenna 62a with Z=0 at a surface of the antenna pad 62. The perimeter of the antenna 62a is associated with coordinates X1, Y1 in the plane of the antenna pad 62. An outermost extent of each of the cartridges 402a-402d is associated with coordinates X2, Y2, Z2. For example, the data storage device 402a presents an outermost corner positioned at coordinates X2, Y2, Z2. Following this convention, the data storage device 402c presents an outermost corner of the cartridge located at −X2, −Y2, Z2. It is desired to optimize the field output from the antenna 62a to ensure that all of the device RFID tags 60 are readable by the antenna 62a, even if the tags 60 are placed at the outermost corners, and to minimize the far field emission from antenna 62a in compliance with various governmental regulations.

Table 1 provides exemplary dimensions (in meters) for sizing the antenna 62a to minimize far field emissions, and provides dimensions that result in maximizing the output of the antenna 62a. A separate set of dimensions is provided for minimizing the conductance (Q) of antenna 62a. Note that the dimensions in Table 1 are positive, such that an entire X axis dimension for a size of the antenna 62a is obtained by calculating the distance between the minus X position (−X) and the positive X axis dimension (+X) in reference to FIG. 1B. For example, one exemplary dimension of an antenna for minimizing the far field emission is 0.5 m by 0.27 m (or twice the dimensions in Table 1). Case 1 recognizes a general orientation of the case 404 relative to the antenna pad 62, and case 2 is specific to an orientation in which the filed of the antenna 62a reads the device RFID tags 60 through the cover 414.

With reference to Table 1, in one embodiment the antenna 62a is sized to have an X axis dimension of about 480 mm and a Y axis dimension of about 280 mm to minimize far field emission from the antenna 62a. In another embodiment, the antenna 62a is sized to have an X axis dimension of about 700 mm and a Y axis dimension of about 500 mm to maximize the output of the antenna 62a relative to the current through the antenna 62a. It is desired, in general, to configure the antenna 62a to have dimensions roughly within these parameters in balancing the power/range of the antenna 62a with the emitted field of the antenna 62a. To this end, one of skill in the art of antennas will readily recognize that other dimensions for the antenna 62a are also acceptable.

TABLE 1

| | |
|---|---|
| Antenna | Location of |
| Size (m) | Device Corners (m) |

| | | X1 | Y1 | X2 | Y2 | Z2 |
|---|---|---|---|---|---|---|
| Minimize | Case 1 | .25 | .135 | .18 | .1 | .15 |
| Far Field | Case 2 | .24 | .14 | .18 | .1 | .1 |
| Emissions | | | | | | |
| Maximize | Case 1 | .35 | .25 | .18 | .1 | .15 |
| Antenna | Case 2 | .29 | .2 | .18 | .1 | .1 |
| Output | | | | | | |

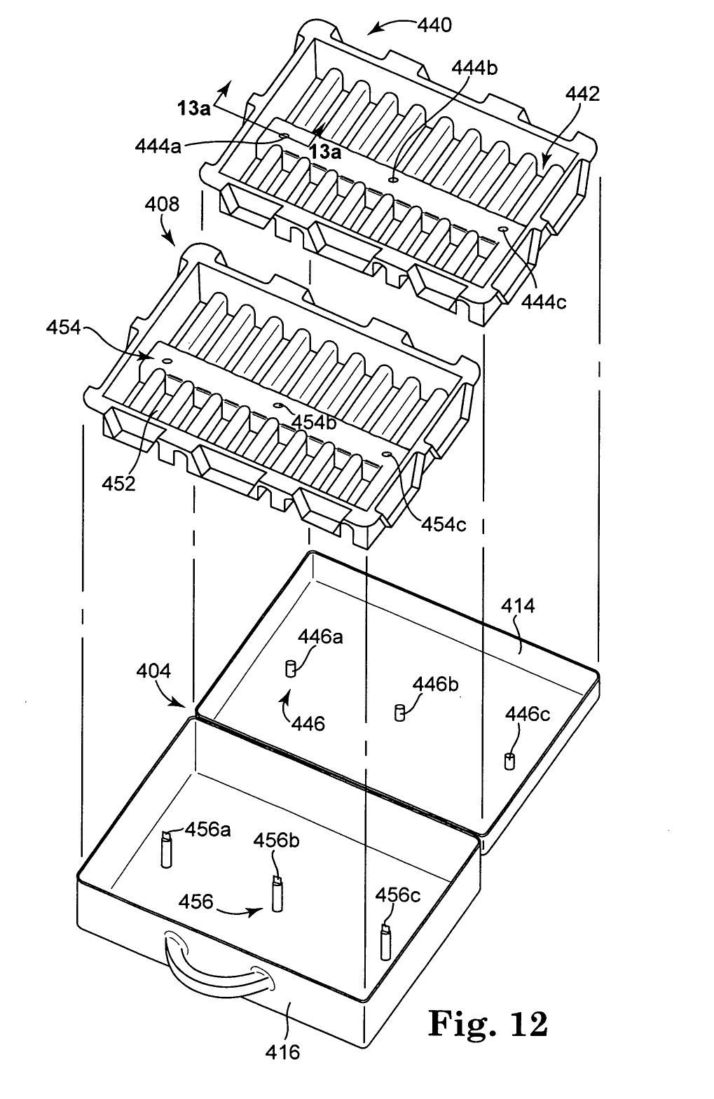

FIG. 12 illustrates an exploded, perspective view of the base insert 408 and a cover insert 440 extracted from the case 404 according to one embodiment of the present invention. The cover insert 440 is preferably durably retained within the cover 414 as the cover 414 moves between the open and closed positions. In general, the cover insert 440 defines a plurality of device slots 442 and relief portions 444 that mate with projections 446 extending from an interior of the cover 414. In particular, in one embodiment the cover insert 440 defines three relief portions 444a, 444b and 444c that mate with a respective projection 446a, 446b and 446c that extend from the cover 414. In some embodiments, it is desirable to semi-permanently mate the projections 446 with the relief portions 444 in a manner that necessitates the destruction of one or both of the projections 446 and/or the relief portions 444 when removing the cover insert 440. This ensures that the cover insert 440 will be retained within the cover 414, unless or until it is desired to forcefully remove the cover insert 440, during maintenance of the case 404, for example.

In one embodiment, the base insert 408 includes a plurality of device slots 452 and defines relief portions 454a, 454b, 45c that are sized to mate with projections 456a, 456b, 456c, respectively, extending from an interior of the base portion 416. Each of the device slots 452 is sized to frictionally retain an individual one of the data storage devices 402 in a manner that orients the device RFID tag 60 perpendicular to the field that is generated by the pad antenna 62 (FIG. 11A). In this regard, in one embodiment the base insert 408 is formed of a compliant material that enables each one of these slots 452 to accept a device 402 that is pressed into the slot 452.

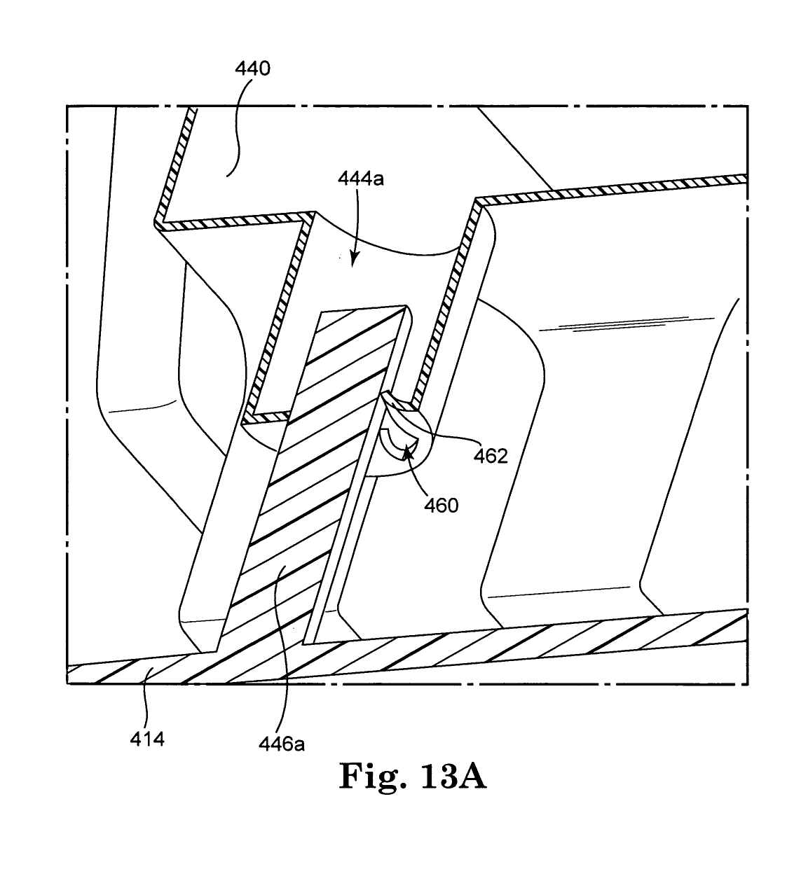

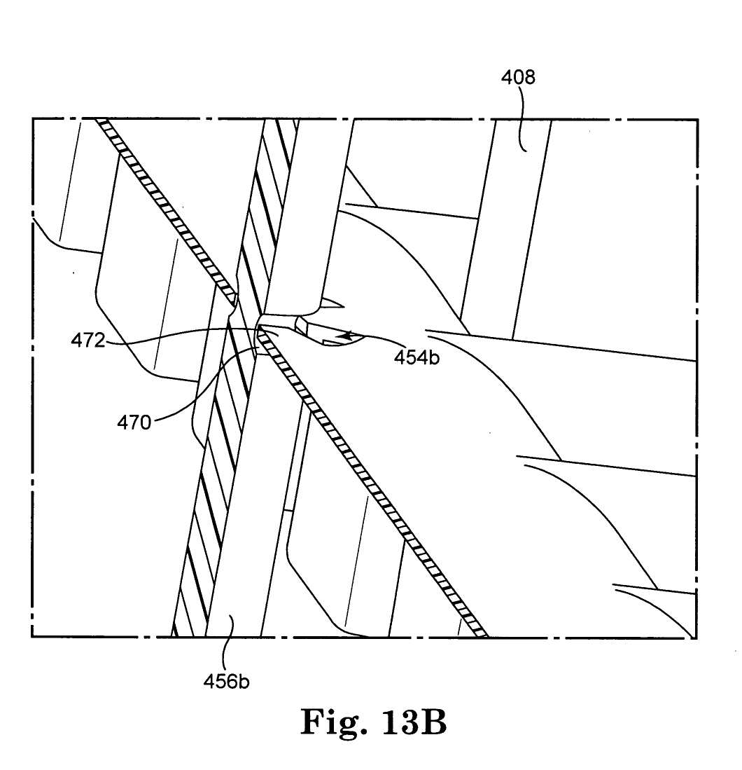

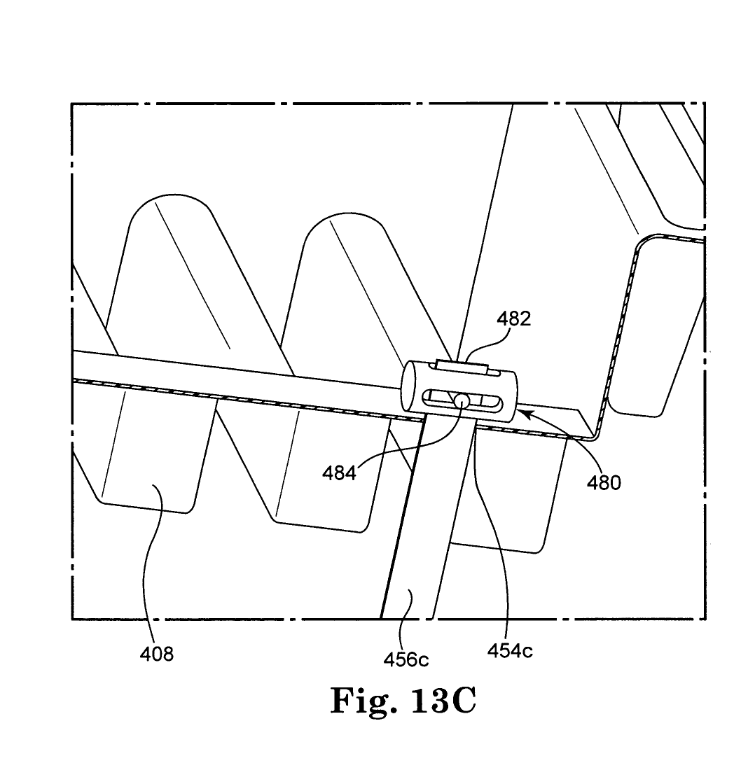

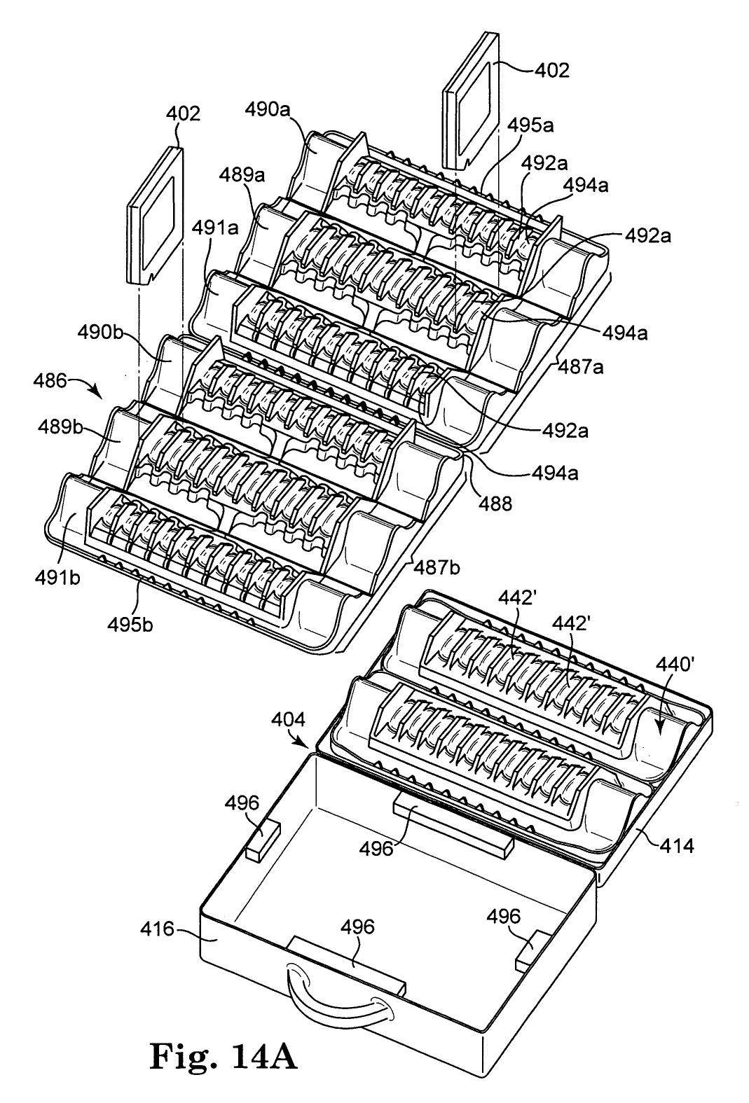

FIG. 13A illustrates a cross-sectional view of the cover insert 440 engaged with the projection 446a. In one embodiment, each relief portion 444 defines a star-shaped opening 460 that is formed by one or more flanges 462. In general, it is desired that the cover insert 440 be secured against unintended removal from the cover 414. In one embodiment, the flanges 462 are configured to deform around the projection 446a such that the flanges 462 are destructively attached to the projection 446a. That is to say, the flanges 462 are compressed against the projection 446a in a manner that prevents the projection 446a from backing out (or away) from the flanges 462. In this regard, the relief portion 444a defines a lock that can be push-fit against the projection 446a such that the flange 462 bends up (relative to the orientation of FIG. 13A) and prevents the cover insert 440 from slidably releasing from the projection 446. An attempt to withdraw the cover insert 440 from the cover 414 will destroy one or more of the flanges 462. Thus, in one embodiment the cover insert 440 is a part of a reusable cover 414 that would not be changed out except when the cover 414 becomes damaged and is replaced in its entirety during maintenance of the cover 414.

FIG. 13B illustrates the base insert 408 removably locked relative to a projection 456b of the base 416. In one embodiment, the projection 456b is a uniformly smooth cylindrical projection that is sized to press-fit into a circular relief portion 454b such that the base insert 408 is retained within the base 416. In another embodiment, the projection 456b defines a collar 470 that is relieved to removably retain a flexible flange 472 of the relief portion 454b. The relief portion 454b removably locks relative to the projection 456b by enabling the flexible flange 472 to equilibrate to a neutral position within the collar 470. In this manner, the base insert 408 can be pulled off of the projection 456b for removal or maintenance.

FIG. 13C illustrates the base insert 408 selectively locked relative to a projection 456c of the base 416. In one embodiment, the projection 456c slideably mates with the relief portion 454c (best illustrated in FIG. 12) and a retainer assembly 480 is coupled to a top 482 of the projection 456c to removably retain the base insert 408 within the base 416. In one embodiment, the retainer assembly 480 includes a spring loaded peg 484 that biases between an open position and a closed position. In the open position, the spring loaded peg 484 is configured to provide clearance for the retainer assembly 480 to slide over the top 482 of the projection 456c. In the closed position, the spring loaded peg 484 clasps against the projection 456c to retain the base insert 408 inside the base 416 by preloading the base insert 408 against the projection 456c.

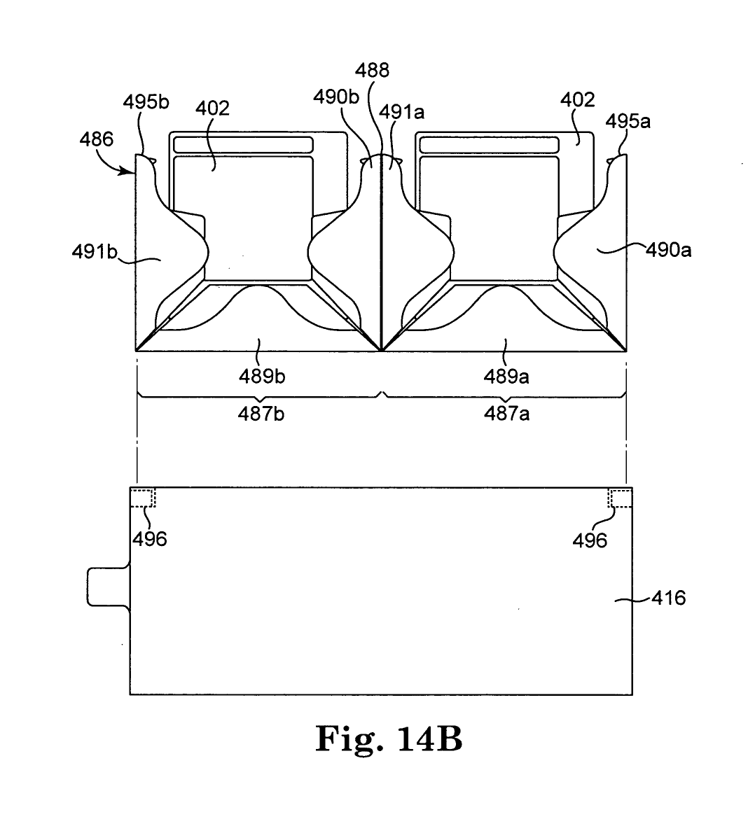

FIG. 14A illustrates a perspective, exploded view of the case 404 and an insert system 485 configured to retain multiple data storage devices 402 according to one embodiment of the present invention. The insert system 485 includes a cover insert 440′ and a base insert 486. The insert system 485 protectively retains the devices 402 within the case 404. The insert system 485 is configured to absorb jarring impacts and protect the devices 402 from shock. In this regard, it is desired to flexibly retain the insert system 485 within the case 404 in a manner that minimizes a rigid transfer of shock between the case 404 and the insert system 485 within the case 404, such that the devices 402 are isolated from shocks and bumps.

The cover insert 440′ is preferably durably retained within the cover 414 and defines a plurality of device slots 442′ that are sized to frictionally engage one end of a device 402 when the cover 414 is closed over the devices 402. In this manner, the cover insert 440′ is similar to the cover insert described in FIG. 12 above, and can include relief portions that mate with projections extending from an interior of the cover 414. In another embodiment, the cover insert 440′ is sized to be removably press-fit within an interior perimeter of the cover 414. The cover insert 440′ can be attached to an interior of the cover 414 by adhesive or mechanical fasteners such as hoop and loop fabric fasteners.

The base insert 486 includes a pair of foldable panels 487a and 487b hinged about an approximate central spine 488. Each of the panels 487a, 487b defines a respective seat portion 489a, 489b and opposing wings 490a, 491a and 490b, 491b that fold relative to the seat portions 489a, 489b. The seat portion 489a and the opposing wings 490a, 491a define device separators 492a. When the opposing wings 490a, 491a are folded over devices 402 placed in the seat portion 489a, the separators 492a separate the devices 402 for retention within a device slot 494a. In a similar manner, the seat portion 489b and the opposing wings 490b, 491 b define device separators 492b such that when the opposing wings 490b, 491b are folded over devices 402 placed in the seat portion 489b, the separators 492b separate the devices 402 for retention within a device slot 494b. An outer side of each panel 487a, 487b defines a flange 495a, 495b, respectively, that is configured to be retained within lips 496 formed within the base 416.

The base insert 486 is formed of thermoplastic materials and can be formed in a variety of processes, such as blow molding, injection molding, press molding or other thermoplastic fabrication processes. In one embodiment, the base insert 486 is molded of an ultra low density polyethylene film (or a really low density polyethylene RLDPE), although other suitable polymers are also acceptable. For example, in one embodiment the base insert 486 is formed of a foamed thermoplastic material. In one embodiment, the base insert 486 is formed to be compliant such that when the insert 486 is retained within the base 416 it offers vibration damping and shock absorption that is useful in protecting the devices 402.

FIG. 14B illustrates an exploded side view of the base insert 486 folded around multiple data storage devices 402 and positioned relative to the base 416 of the cases 404. In this regard, to simplify the view of FIG. 14B, the cover 414 is not shown as attached to the base 416. The base insert 486 has been folded such that the panel 487a has been retracted relative to the central spine 488 and the wings 490a, 491a have been folded about the seat portion 489a to retain one or a row of the data storage device(s) 402. In a similar manner of folding, the panel 487b has been retracted relative to the central spine 488 and the wings 490b, 491b have been folded about the seat portion 489b to retain a separate one (or a separate row) of the data storage device(s) 402.

In the folded configuration illustrated in FIG. 14B, the flanges 495a, 495b are presented in a position opposite of the seat portions 489a, 489b such that the flanges are poised for retention within the base 416. With this in mind, although multiple devices 402 are illustrated as retained by the base insert 486, a more typical deployment would include folding the panels 487a, 487b toward one another absent the devices 402 and inserting the empty base insert 486 into the base 416. Thereafter, the wings 490a and 491b are extended upward such that the flanges 495a, 495b, respectively, are retained by the lips 496. The central spine 488 may then be fully seated within the base 416, and the devices 402 stowed in the base insert 486.

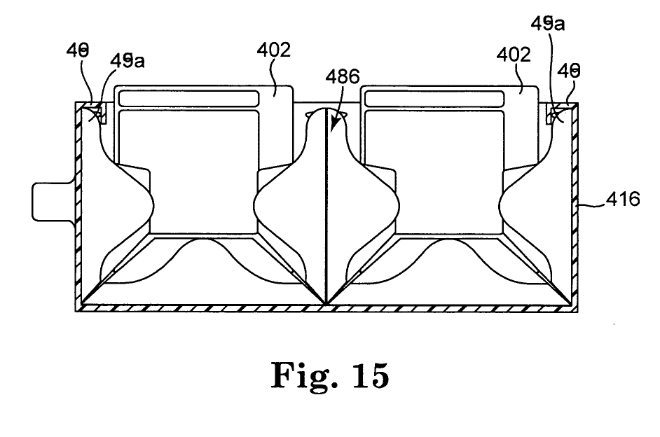

FIG. 15 illustrates a cross-sectional view of the base insert 486 retained within the base 416. The flanges 495a, 495b are retained by the lips 496 such that the base insert 486 is configured to be compliantly movable within the base 416. In this manner, the base insert 486 can move relative to the base 416 to facilitate shock absorption and vibration damping, which contribute to the protection of the devices retained by the base insert 486.

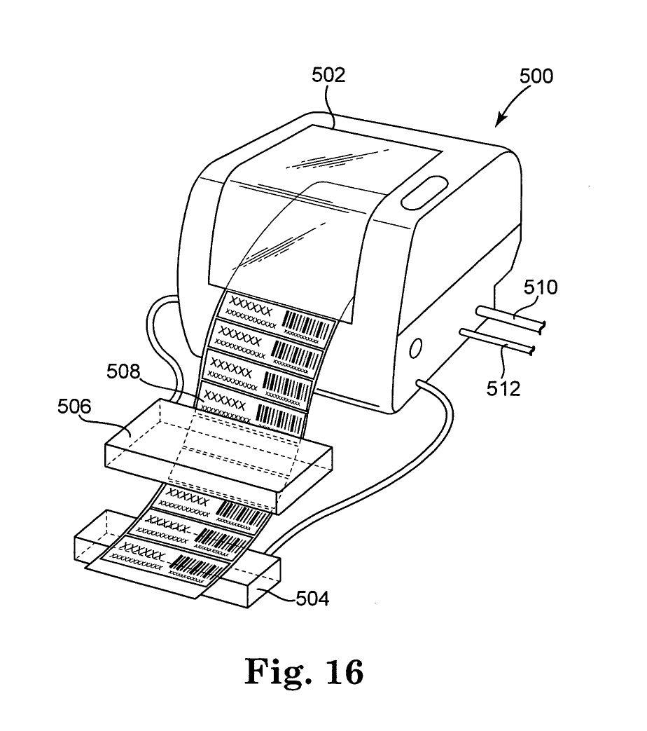

FIG. 16 illustrates a perspective view of a printer system 500 according to one embodiment of the present invention. The printer system 500 includes a label printer 502 coupled to an RFID reader 504 and an optical reader 506, both of which are in electrical communication with the printer 502. The label printer 502 is operable to print labels 508 that include at least one of a volser number, a volser color code, and/or a volser bar code suitable for optical reading (including human viewing). The optical reader 506 is configured to read the printed labels 508 and communicate with the RFID reader 504. The RFID reader 504 is configured to write a corresponding volser number and a corresponding volser CRC (along with other electronic data) to an IC chip (not shown) of an RFID tag within the labels 508. In this regard, the label printer 502 includes a power source connection 510, and an output connection 512, such as an Ethernet connection or a universal serial bus (USB), that couples to the GUI 66 (FIG. 1).

The label 508 in one embodiment is highly similar to the optical label 58 (FIG. 2). In this regard, the printer system 500 is operable to electronically transfer from the GUI 66 (FIG. 1) any of the cartridge data stored on the GUI 66 that the user desires to write to the label 508. This is useful in assigning a new label to replace a damaged (or unreadable) label as the data storage device 52 (FIG. 1) enters/exits the system 50. To this end, the label 508 is printable with bar code and other optically readable data (such as a cartridge type code, a manufacturer code, the volser number, the media number, and a date code), and any or all of this same data can be electronically written to a chip within the label 508 by the reader 504.

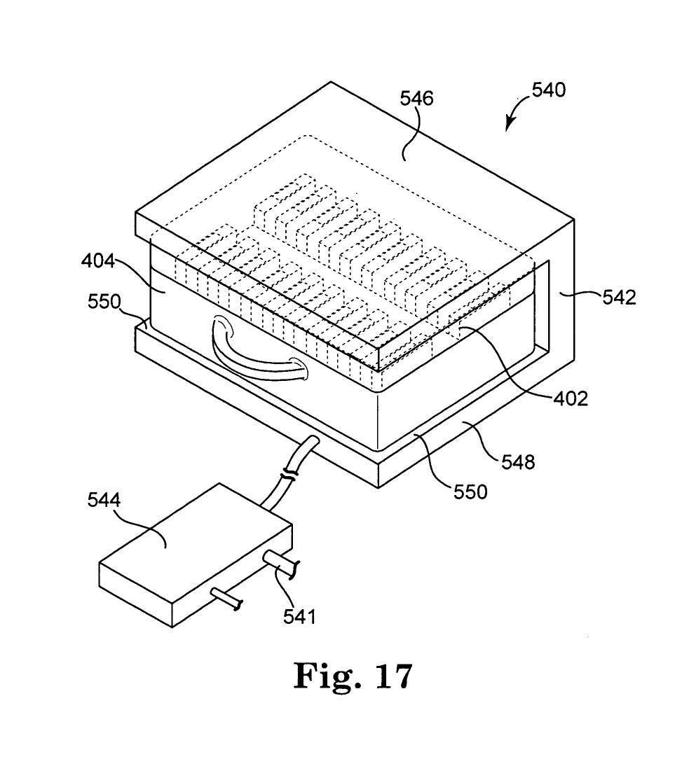

FIG. 17 illustrates a perspective of a reader system 540 according to another embodiment of the present invention. The reader system 540 is configured to provide an extensive radiofrequency field that is enabled to read RFID tags irrespective of the orientation of the RFID tag. In this regard, the reader system 540 includes a U-shaped antenna assembly 542 and a transceiver 544. The U-shaped antenna assembly 542 includes multiple antennas, including at least a first antenna 546 and an opposing second antenna 548, both of which are electrically coupled to the transceiver 544. The first and second antennas 546, 548 are disposed in opposing portions of the U-shaped antenna assembly 542 that is otherwise configured to accommodate the case 404 storing multiple data storage devices 402. The transceiver 544 includes an output connector 541 that is suited for connection to a graphical user interface, such as the GUI 66 (FIG. 1), that enables the sharing of data between the GUI 66 and the transceiver 544.

In one embodiment, it is desired that each of the first and second antennas 546, 548 include an antenna having dimensions of about 350 mm×420 mm, although it is to be understood that other sizes of antennas are suitable and within the scope of this invention. Certain larger cases are more effectively read by an antenna having dimensions of about 370 mm×470 mm, for example. To this end, one embodiment of the U-shaped antenna assembly 542 provides guides 550 that are configured to position the case 404 at a desired location within a read field of the U-shaped antenna assembly 542.

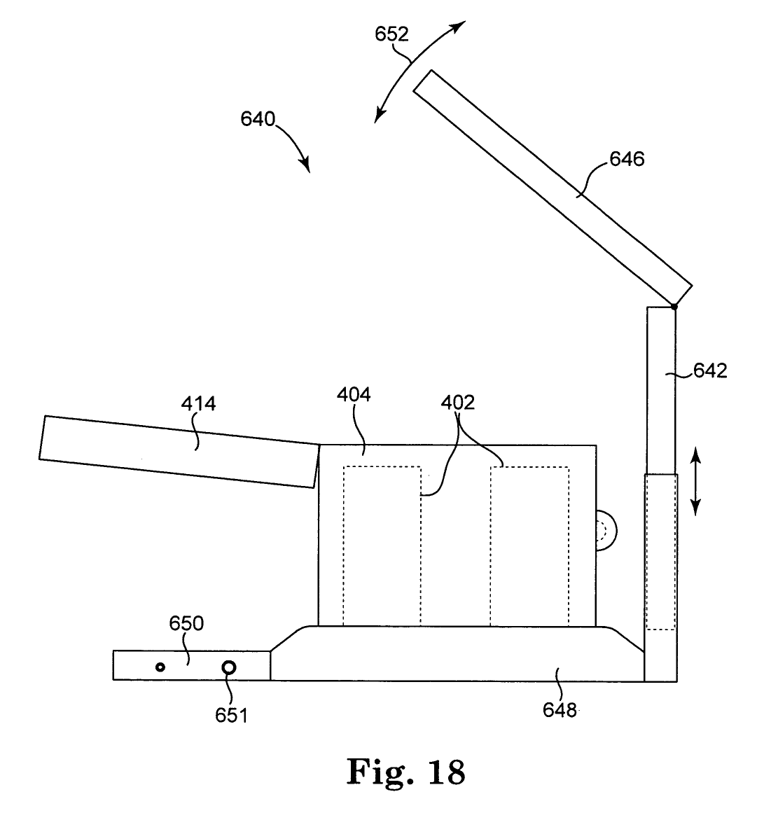

FIG. 18 illustrates a reader system 640 according to another embodiment of the present invention. The reader system 640 includes an adjustable antenna support 642 having a first hinged antenna 646 hinged to the adjustable antenna support 642, a second fixed antenna 648, and an RFID transceiver 650 in electrical communication with the antenna support 642. The RFID transceiver 650 includes an output connector 651 suited for connection to a graphical user interface, such as the GUI 66 (FIG. 1), that enables the sharing of data between the GUI 66 and the RFID transceiver 650.

In one embodiment, the adjustable antenna support 642 is height-adjustable, and the hinged antenna 646 is configured to move in an arc 652 of at least 90 degrees relative to the adjustable antenna support 642. The antennas 646, 648 are sized to ensure radiofrequency reading of randomly oriented multiple data storage devices 402 stored in a generalized metallic case 404, for example. With this in mind, in an exemplary embodiment the hinged antenna 646 and the fixed antenna 648 each includes an antenna area of about 350 mm×390 mm.

Metallic cases 404 can interfere with RFID reading of the device RFID tags 60 (FIG. 11A) attached to the devices 402. The adjustable antenna support 642 is configured to accommodate a variety of case sizes and shapes, and the antenna 646 can be displaced to permit easy opening of the case 404, which is especially useful with metallic cases and in situations where a read error occurs with one of the devices 402. After positioning the cases within the antenna support 642, the hinged antenna 646 is moved into a downward position over the exposed data storage devices 402 to enable reading of the device RFID tags 60 on the data storage devices 402. In one embodiment, at least one of the first hinged antenna 646 and the second antenna 648 is provided with guides (not shown) that assist in aligning the case 404 relative to the hinged antenna 646 to ensure that the devices 402 are within the field of the antennas 646, 648.

In another embodiment, the antenna support 642 includes an embedded antenna (not shown) that is substantially similar to the antennas described above and configured to provide a field orthogonal to the fields generated by the antennas 646, 648. In this manner, the magnetic fields produced by the reader system 640 produce an optimized output with a minimum level of far field emissions.

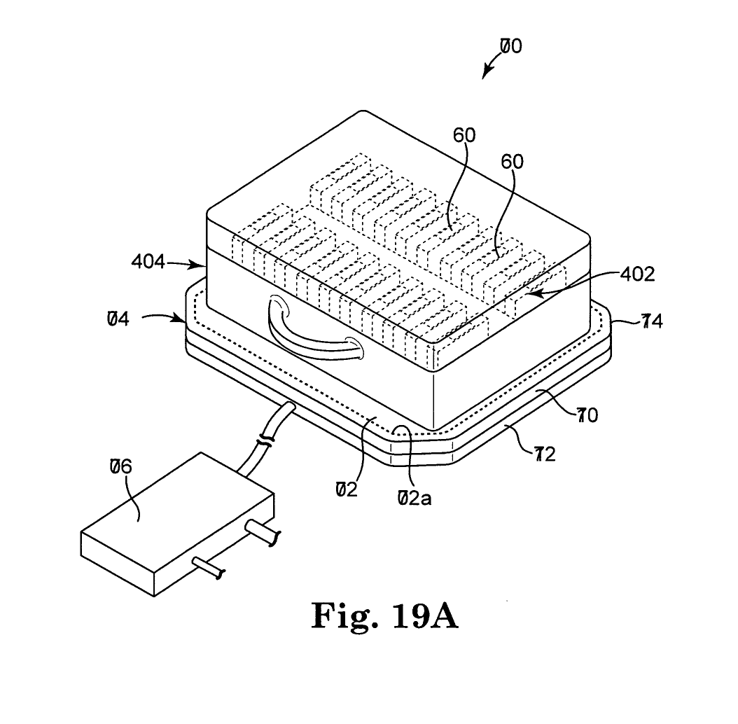

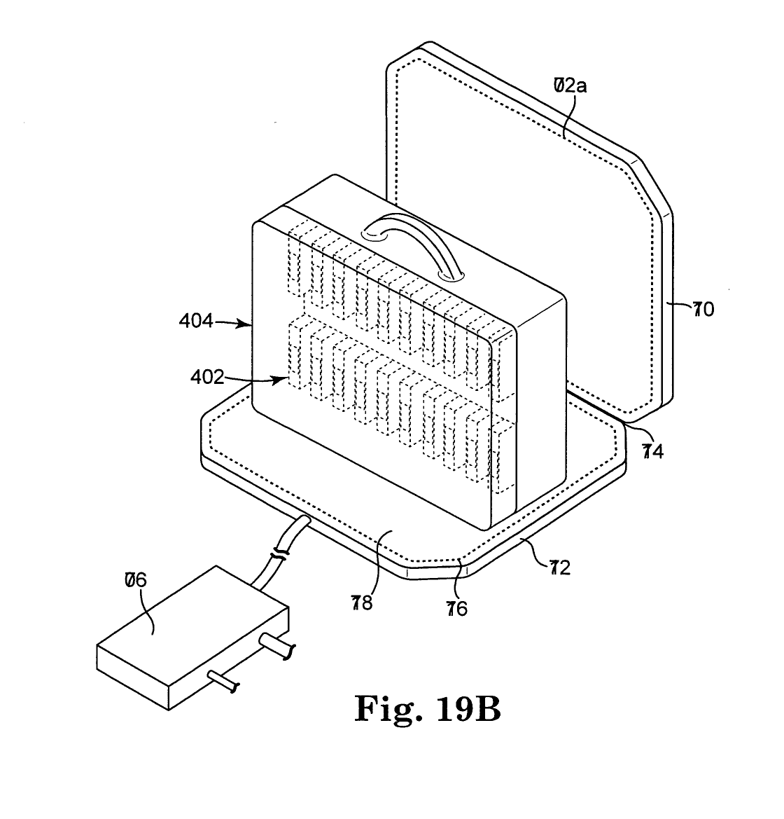

FIG. 19A illustrates a perspective view of a reader system 700 according to another embodiment of the present invention. The case 404 of data storage devices 402 is position on a first antenna surface 702 of a flip antenna assembly 704 that is electrically coupled to a transceiver/reader unit 706.

The flip antenna assembly 704 includes a first panel 710 and a second panel 712 that is rotatably connected to the first panel 710 along a hinged spine 714, for example. The first panel 710 includes the first antenna surface 702 provided with an embedded antenna 702a, the combination of which is configured to receive the case 404 and read the device RFID tags 60 attached to the storage devices 402. The first panel 710 is configured to rotate away from, and off of, the second panel 712 to produce intersecting RFID read fields. In this manner, two orthogonal fields are generated emanating from the first and second panels 710, 712, respectively, as best illustrated in FIG. 19B below, which enables RFID reading of device RFID tags 60 that might potentially be obscured from the field of one of the panels 710, 712.

The antennas within the panels 710, 712 are substantially similar to the antennas described above, including the antenna 62a (FIG. 1). In one embodiment, the antennas each have an antenna area of about 350 mm×390 mm, although other antenna sizes are also acceptable. The reader unit 706 is similar to the reader unit 64 described above, and communicates with software operable by the reader system 700 when communicating with the GUI 66 (FIG. 1).

FIG. 19B illustrates a perspective view of the reader system 700 showing the first panel 710 rotated around the hinged spine 714 to a second read position that is substantially orthogonal to the second panel 712. The antenna 702a of the first panel 710 emits a magnetic field that is oriented substantially perpendicular to a field emitted by a second antenna 716 embedded within a surface 718 of the second panel 712.

The panels 710, 712 described above are configured to produce a maximum magnetic field output from the antennas 702a, 716 while minimizing the far field emissions in a region near the reader system 700. In particular, since the panel 710 can be rotated relative to the panel 712, the field output from the respective antennas 702a, 716 is orientation-variable, and thus adjustable, to enable optimizing the emitted field. In this manner, the device RFID tags 60 are “readable” even if the case 404, or metal in a data storage device, interferes with the fields, or is less than optimally positioned relative to the reader system 700.

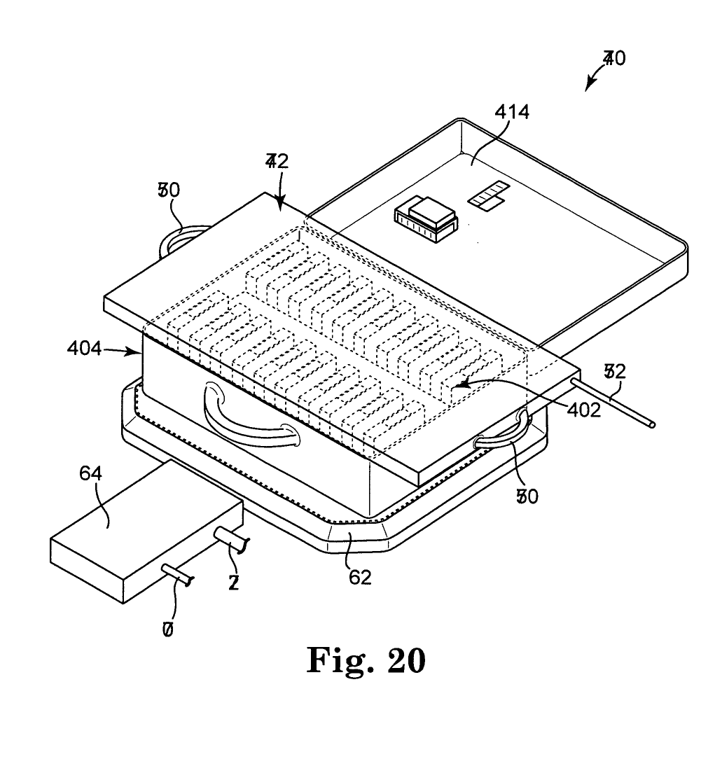

FIG. 20 illustrates a perspective view of a reader system 740 according to another embodiment of the present invention. The cover 414 of the case 404 is illustrated in the open position for descriptive purposes, although it is to be understood that in some embodiments the reader system 740 reads the device RFID tags 60 through a closed case 404.

The reader system 740 includes a portable antenna 742 in communication with the pad antenna 62a and the reader unit 64 of the reader system 54 illustrated in FIG. 1. The portable antenna 742 is sized to be manipulated by the user in providing a separate RFID field from an embedded antenna (not shown), for example, that compliments the field generated by the pad antenna 62, thus ensuring that all of the device RFID tags 60 enter into a read field of the reader system 740. The antenna within the portable antenna 742 is substantially similar to the antennas described above, including the antenna 62a (FIG. 1). In one embodiment, the portable antenna 742 has an antenna area of about 350 mm×390 mm, although other antenna sizes are also acceptable. The portable antenna 742 additionally includes handles 750 configured to be grasped by an operator, and includes an electrical connector 752 for electrical connection to the reader unit 64 and the GUI 66 (FIG. 1).

In the embodiments described above, the reader systems can employ separate read and write antennas. In this regard, multiple antennas may be used with a reader system, particularly to increase a read range without exceeding regulated electromagnetic field limits. Recall, in some jurisdictions government regulations specify limits for maximum electromagnetic field strength, and it can be desirable to have multiple (and less powerful) antennas that each are within the field guidelines where each antenna contributes to the read field of the reader system. In this regard, the multiple antennas used in the reader systems described above will increase the read range of the RFID reader without exceeding field limits.

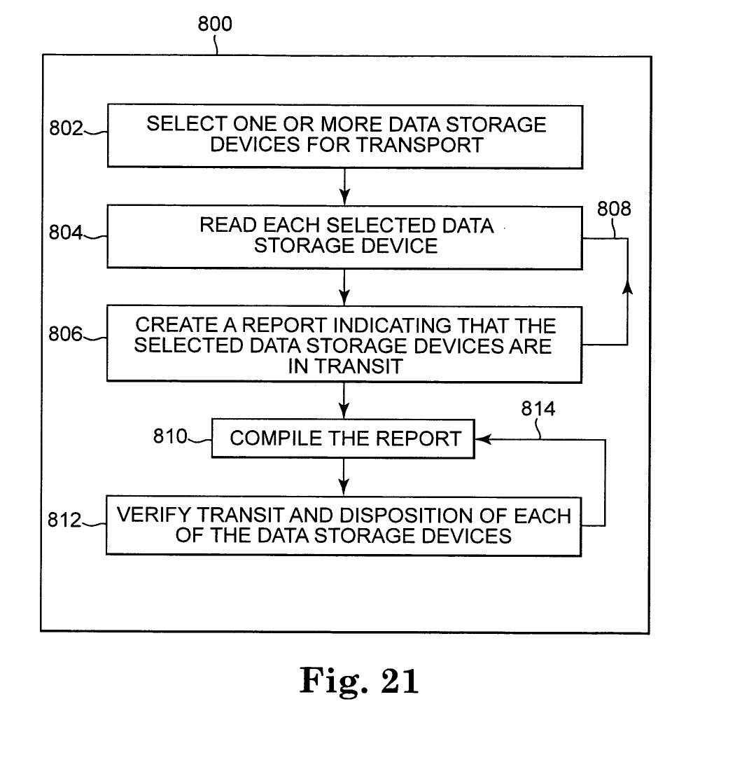

FIG. 21 illustrates a flow chart 800 of a process for tracing one or more data storage devices in transit according to one embodiment of the present invention. With additional reference to FIG. 11A, the flow chart 800 describes a process by which one or more data storage devices 402 are pulled or selected for transport from a facility, the data storage devices 402 are read by the reader system 54, the GUI 66 creates a report identifying which of the devices 402 have been selected for transit, and the GUI software (not shown) compiles a report and is operable to electronically verify transit and/or reception of the devices 402.

In particular, the flow chart 800 provides a process 802 for selecting one or more data storage devices for transport. In this regard, transport could include transit from a facility (such as backup devices leaving a business office for storage), or transit into a facility (such as backup devices returning to the business office from a secure storage site). Process 804 provides for reading (optically and/or electronically) each selected data storage device 402. It is to be understood that each device 402 includes the device RFID tag 60 described above. The reader system 54 is operable to RFID read/identify one or multiple of the devices 402 that are on or within a field that is generated by the pad antenna 62. In this manner, the unique 64 bit tag ID, the RFID revision field, the volser number, the CRC check sum, the cartridge manufacturer's serial number, and/or any other user-defined field that is electronically stored on the chip 142 (FIG. 3A-3C) is simultaneously and individually read by the reader system 54.

Thereafter, the GUI 66 is operable to create a report that indicates the selected storage devices 402 are in transit, or scheduled for transit, or have been received, or are scheduled to be received. As a point of reference, the GUI 66 might create a report that indicates one or more of the devices 402 has not been correctly read, or has not been read at all. Loop 808 illustrates the use of the portable reader device 420 employed to selectively read and confirm the presence of one or more such devices 402.

After the report has been created by the GUI 66, a user is able to operate the GUI 66 to compile the report in process 810. In one embodiment, process 810 compiles the report and is operable to write a file electronically to the GUI 66 that is stored or transferred to other systems/networks. For example, in one embodiment the user employs the process 810 to compile a report in a spreadsheet application, or in a word processing application or other program suited for data processing. The report is file-shared with the originator of the devices 402 to inform the originator that the devices 402 are being traced. In this regard, the file-sharing can be network-based and/or sent automatically via the Internet, for example.

Process 812 provides for verifying transit and disposition of each of the data storage devices 402 identified in the compiled report. For example, in one embodiment the process 812 sends an e-mail to the user and to an intended recipient notifying each that the selected data storage devices have been scheduled for transit and are expected to arrive at the indicated/selected terminus at a projected time. Loop 814 provides for redundancy checking and the verification of the transit of the data storage devices 402 by double checking with the compiled report and process 810.

Flowchart 800 illustrates but one embodiment of the electronic data storage device tracing system 50 employed to identify and trace data storage devices. Those with skill in the art of data generation and protection will recognize that the systems described above are operable in any number of ways to sense/read/write RFID tags located within an electromagnetic field of an antenna, and trace and report on the tracing of the devices to which the tags are attached.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of data storage device tracing and tracking systems discussed herein. Therefore, it is intended that this invention be limited only by the claims and the equivalents thereof.

1. An electronic data storage device tracing system comprising:
at least one data storage device including:
a housing having a label and a device RFID tag coupled to the housing, the label printed with a volser number and the device RFID tag including a chip electronically storing the volser number; and
a reader system configured to read the volser number from the chip and trace the at least one data storage device entering/exiting the reader system.

2. The system of claim 1, wherein the reader system includes an antenna configured to communicate with the device RFID tag, the reader system configured to read the electronically stored volser number and to write a volser number to the chip.

3. The system of claim 1, wherein the reader system comprises a reader unit configured to contactlessly read the volser number from the chip and a graphical user interface configured to communicate with the reader unit, the graphical user interface configured to store and sort the volser number.

4. The system of claim 3, wherein the graphical user interface is operable to append the volser number and shipping information to a database for each of the at least one data storage devices exiting a facility.

5. The system of claim 3, wherein the graphical user interface is operable to assign a destination location, a receiving location, an expected time of arrival, and an expected time of departure to the at least one data storage device.

6. The system of claim 3, wherein the graphical user interface comprises software that is operable to write an electronic file and export the written electronic file to data management software.

7. The system of claim 4 comprising a plurality of data storage devices stowed within a case that is provided with a case RFID tag, the reader unit configured to read the case RFID tag and each devices RFID tag of the plurality of data storage devices and communicate with software, the software configured to confirm the presence of the data storage devices stowed within the case.

8. The system of claim 7, wherein the case comprises a global positioning system that is configured to track a location of the case and the plurality of data storage devices stowed within the case.

9. The system of claim 7, wherein the reader system is configured to read the volser number of each device RFID tag coupled to each data storage device and operable to read the information stored on the case RFID tag.

10. The system of claim 7, wherein the reader system includes an antenna and the case includes an insert configured to orient each device RFID tag perpendicular to an electromagnetic field of the antenna.

11. The system of claim 1, wherein the device RFID tag is coupled between the housing and the label.

12. The system of claim 1, wherein the device RFID tag is coupled to an interior surface of the housing.

13. The system of claim 1, wherein the label comprises an optical label that is printed with fat least one optically readable field.

14. The system of claim 13, wherein the chip electronically stores including at least the data printed on the optical label.

15. The system of claim 1, wherein the volser number of the chip is encrypted.

16. The system of claim 1, wherein the volser number comprises a unique identification number for the least one data storage device and the chip comprises a check sum of at lease the unique identification number.

17. The system of claim 1, wherein the data storage device is one of a data storage tape cartridge, a hard disk drive, and a removable memory device.

18. An electronic data storage device tracing system comprising:
means for reading volser data from a plurality of data storage devices;
means for compiling a report related to the volser data; and
means for tracing the plurality of data storage devices based upon the compiled report.

19. The tracing system of claim 18, wherein the means for reading volser data from a plurality of data storage devices comprises a device RFID tag coupled to each of the plurality of data storage devices and a reader system that is operable to read at least one field of electronic data stored in electronic memory chips of each of the device RFID tags.

20. The tracing system of claim 18, wherein the plurality of data storage devices is contained within a case including a GPS unit, and further wherein the means for tracing the plurality of data storage devices comprises tracking a global position of the case via tracking a longitude and latitude output by the GPS unit.

21. The system of claim1, wherein the label is coupled to the device RFID tag and the device RFID tag is coupled to an exterior of the housing.

22. The system of claim 11, wherein the at least one data storage device comprises a retrofitted data storage device including the device RFID tag coupled to the exterior of the housing and the label is coupled to the device RFID tag and the exterior of the housing.
